(19) United States
(12) Patent Application Publication
(10) Pub. No.: US 2021/0230478 A1
(43) Pub. Date: Jul. 29, 2021

(54) PARTICULATE COMPOSITIONS CONTAINING OIL FIELD CHEMICALS

(71) Applicant: ExxonMobil Research and Engineering Company, Annandale, NJ (US)

(72) Inventors: Fang Cao, Basking Ridge, NJ (US); Yao Xiong, Cypress, TX (US); James D. Oxley, Helotes, TX (US); Wei Li, Spring, TX (US); Satish Bodige, Wayne, NJ (US); Abhimanyu O. Patil, Westfield, NJ (US); Harry W. Deckman, Clinton, NJ (US)

(21) Appl. No.: 17/147,631

(22) Filed: Jan. 13, 2021

Related U.S. Application Data
(60) Provisional application No. 62/966,256, filed on Jan. 27, 2020.

(51) Int. Cl. C09K 8/92; C09K 8/54; C09K 8/60; C09K 8/52; E21B 37/06; E21B 41/02

(52) U.S. Cl. CPC C09K 8/92; C09K 8/54; C09K 8/605; C09K 8/52; C09K 2208/28; E21B 37/06; E21B 41/02; C09K 2208/32; C09K 2208/22; C09K 8/602

(57) ABSTRACT

Particulate compositions including a plurality of particles containing oil field chemicals encapsulated in a water soluble, water swellable, or water degradable matrix material are disclosed. The oil field chemicals may be corrosion inhibitors and the particulate composition may be prepared by spray drying mixtures of matrix material and oil field chemicals. The particulate compositions are designed to efficiently deliver the chemicals to the water phase of a multiphase environment, such as an oil/water environment.

### CROSS-REFERENCE TO RELATED APPLICATIONS

This application is related to and claims the benefit of priority from U.S. Provisional Application No. 62/966,256 filed Jan. 27, 2020, which is hereby incorporated by reference in its entirety.

### FIELD OF THE INVENTION

This disclosure relates to particulate compositions containing oil field chemicals and to methods of their preparation and use. The particulate compositions contain the chemicals encapsulated in a water soluble, water swellable, or water degradable matrix material and may be designed to efficiently deliver the chemicals to, for example, the water phase of a multiphase environment, such as an oil/water environment. The particulate compositions may be prepared by various methods, including spray drying.

### BACKGROUND OF THE INVENTION

Production chemistry issues in the oil and gas industry result from changes in well stream fluids, both liquid and gaseous, during processing. Since crude oil and gas production are characterized by variable production rates and unpredictable changes to the nature of the produced fluids, it is essential to have a range of oil and gas field chemicals available for rectifying issues that would not otherwise be fully resolved. Thus, oil and gas production chemicals are necessary to overcome or minimize the effects of such production chemistry problems.

In general, production chemistry problems relate to the following:
Problems caused by fouling. This is typically the deposition of any unwanted matter in a system and includes scales, corrosion products, wax (paraffin wax), asphaltenes, naphthenates, biofouling, and gas hydrates.
Problems caused by the physical properties of the fluid. Examples include foams, emulsions, and viscous flow.
Problems that affect the structural integrity of the facilities. These mainly include corrosion-related issues.
Problems that are environmental or economic. For example, oily water discharge can affect the environment, and the presence of sulfur compounds, such as hydrogen sulfide (H2S), has potential environmental and economic consequences.

These problems may be addressed through use of appropriately selected oil or gas field chemicals. Oil and gas production chemicals are therefore employed to overcome or minimize the effects of the production chemistry problems listed above. Briefly, they may be classified as follows:
Inhibitors to minimize fouling and solvents to remove preexisting deposits.
Process aids to improve the separation of gas from liquids and water from oil.
Corrosion inhibitors to improve integrity management.
Chemicals added for some other benefit, including environmental compliance.

Further, upstream of the wellhead, production chemistry deposition problems include to scale and asphaltene deposition, and even wax deposition if the temperature in the upper part of the well is low.

Typically, treatment with a scale inhibitor, downhole and/or topside, is required to prevent scaling. Asphaltene, wax, and inorganic scales may all be removed using various chemical dissolver treatments. Corrosion during acid stimulation is a major concern and requires special corrosion inhibitors that tolerate and perform well under very acidic conditions. Other downhole chemical treatments include water and gas shut-off and sand consolidation.

Electrochemical corrosion occurs wherever metals are in contact with water, and this problem affects both the internal surfaces and the exposed external surfaces of facilities and pipelines. The rate of corrosion varies in proportion to the concentrations of water-soluble acid gases such as carbon dioxide (CO₂) and hydrogen sulfide (H₂S), and in proportion to aqueous salinity. It is potentially a serious issue in high-temperature wells, and in this situation, special corrosion-resistant alloys may be economically advantageous. Reducing the concentration of H₂S can alleviate corrosion problems, and this can be addressed by employing H₂S scavengers, biocides/biostats, and nitrate/nitrite injection. Batch or continuous treatment with corrosion inhibitors is normally required to control corrosion to within an acceptable limit for the predicted lifetime of the field.

Several other miscellaneous production chemicals are used in the upstream oil and gas industry. Although H₂S scavenger chemicals reduce corrosion, they may be deployed specifically to avoid refinery problems or for environmental reasons (i.e., to reduce toxicity). Similarly, flocculants can also improve environmental compliance by reducing toxic contaminants in separated water.

Some production chemicals, such as corrosion inhibitors, wax inhibitors, gas hydrate inhibitors and sometimes scale inhibitors and biocides, are dosed to oil export lines. Chemicals for water injection systems include oxygen scavengers to reduce corrosion, biocides to reduce microbially enhanced corrosion and hydrogen sulfide production, water-based drag reducers to increase the water injection rate, scale and corrosion inhibitors, and antifoams.

Oil and gas production chemicals encompass a diverse range of products, technologies and services. The oil field chemicals may be drilling chemicals, production chemicals, cementing chemicals, completion and work over chemicals, enhanced oil recovery chemicals, etc.

Conditions which adversely affect the production of oil from a well include: (1) the deposition of plugging materials brought out during production (e.g., formation of “scale”); and (2) corrosion of the well tubing and operating equipment in the well. Treatment of a well by introducing an oil field chemical can increase the rate of production, prolong the producing life, and lessen the deterioration of well equipment.

As is evident from the foregoing, a wide variety of oil field chemicals are known and are utilized for various purposes. A detailed account may be found in “Production chemicals for the oil and gas industry”, 2nd edition, Malcolm A. Kelland.

In a specific, although non-limiting example, pipelines made of carbon steel which are exposed to wet hydrocarbons containing CO₂ and H₂S may be subject to corrosion over time. This is a common but serious problem encountered in the petroleum industry and its occurrence can result in significant expense due to production downtime and equipment replacement cost. Control and prevention of corrosion using chemical treatment, for example via corrosion inhibitor and biocide injection, is one of the most cost-effective solutions and commonly practiced methods to prevent corrosion in pipelines in the oil and gas industry.

In the case of corrosion inhibitor treatment, the active inhibitor components in commercial corrosion inhibitor packages are usually organic, nitrogen-based surfactants such as amines, imidazoline and derivatives. Due to the amphiphilic nature of surfactants, a significant fraction of the injected corrosion inhibitor will inevitably reside in the oil phase, due to partitioning, and at the oil/water interface. It is important to emphasize that corrosion inhibitor efficiency is, to a large extent, dependent on the inhibitor being present in the water phase, since corrosion primarily occurs when acidic water is in contact with a carbon steel surface. As a result, corrosion inhibitor partitioning into the oil phase can significantly reduce the effectiveness of the inhibitors due to lowered corrosion inhibitor concentration in the water phase. Therefore, to improve the efficiency of corrosion inhibitor treatment in controlling corrosion of carbon steel pipelines, there is a need to minimize corrosion inhibitor loss into the oil phase and maximize the amount of corrosion inhibitor present in the water phase.

For biocide treatment to effectively control microbially influenced corrosion, biocides must be able to penetrate throughout the biofilm and contact the sessile bacteria. As a result, batch and semi-continuous (or slug) methods are normally used for biocide injection. Poor mixing of the biocide due to channeling, chemical degradation of the biocide, or inadequate contact time often results in an ineffective biocide treatment. Targeted biocide delivery directly to the biofilm at the steel surface may desirably enhance the effectiveness of the biocide by providing high concentration gradients which facilitates penetration of the biocide throughout the biomass. In addition, it may reduce the amount of water soluble biocide required for batch and semi-continuous methods because of the reduced biocide loss in the bulk fluid.

Apart from corrosion inhibitors and biocides, other oil field chemicals, such as scale inhibitors, demulsifiers and drag reducing agents, would benefit from targeted delivery to the water phase of an oil/water environment.

Accordingly, in view of the foregoing, it would be desirable to provide alternative compositions and methods for delivering oil or gas field chemicals to production facilities, particularly, although not limited to, multiphase environments.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY OF THE INVENTION

The present disclosure describes particulate compositions comprising a plurality of particles, said particles comprising one or more oil or gas field chemicals encapsulated in a matrix material. Oil or gas field chemicals, for example, corrosion inhibitor, biocide, drag reducing agent, demulsifier, gas hydrate inhibitor and scale inhibitor, may be encapsulated in different particle morphologies, selected from core-shell microcapsules comprising a single layer of matrix material surrounding the encapsulated oil or gas field chemicals, and matrix encapsulated materials. Matrix encapsulated morphology may be selected from particles comprising, a) matrix material comprising encapsulated oil field chemicals, said oil field chemicals being dispersed throughout the matrix material, b) matrix material comprising encapsulated oil field chemicals, said oil field chemicals being dispersed throughout the matrix material, said matrix material being surrounded by a further layer of matrix material substantially absent oil field chemicals, c) multiple cores comprising oil field chemicals, said cores being encapsulated by matrix material, said matrix material being surrounded by a further layer of matrix material substantially absent oil field chemicals, d) multiple cores comprising oil field chemicals, said cores being encapsulated by matrix material, and combinations thereof.

As such, the morphology of the matrix encapsulated materials differs from that of a core-shell microcapsule. The matrix material is either a water degradable, water swellable, or a water soluble material. Advantageous properties and methods of preparing particulate compositions, particularly matrix encapsulated materials, are disclosed. When placed in service, the particulate compositions may be mixed with crude oil or a hydrophobic carrier fluid and injected into a range of oil or gas field facilities, for example, a production pipeline.

The particulate compositions also provide a mechanism of direct delivery of oil field chemicals to the water phase of a multiphase environment, for example, a production pipeline, thus providing a method to deliver water insoluble oil field chemicals to the water phase. This enables oil field chemicals previously considered unsuitable to be considered for use. It also enables the use of different oil field chemical combinations that otherwise may be antagonistic when combined in their neat state.

Reference to oil field chemicals in the present specification should be taken as encompassing all chemicals typically utilized in oil or gas production.

In one aspect the present disclosure provides a particulate composition comprising a water soluble, water swellable, or water degradable matrix material and one or more oil field chemicals; said particles comprising a morphology selected from;
i) matrix encapsulated; and
ii) core-shell encapsulated.

FIG. 1 is a schematic of the various particle morphologies, including core-shell encapsulated morphology and variants a) to d) of matrix encapsulated morphology, according to embodiments of the present disclosure.

As illustrated in FIG. 1, core-shell encapsulated morphology may comprise a single layer of matrix material (1) surrounding the central encapsulated oil field chemicals (2).

Again, referring to FIG. 1, matrix encapsulated morphology may be selected from particles comprising, a) matrix material (1) comprising encapsulated oil field chemicals (2), said oil field chemicals being dispersed throughout the matrix material, b) matrix material (1) comprising encapsulated oil field chemicals (2), said oil field chemicals being dispersed throughout the matrix material, said matrix material being surrounded by a further layer of matrix material (3) substantially absent oil field chemicals, c) multiple cores comprising oil field chemicals (4), said cores being encapsulated by matrix material (1), said matrix material being surrounded by a further layer of matrix material (3) substantially absent oil field chemicals, d) multiple cores comprising oil field chemicals (4), said cores being encapsulated by matrix material (1), and combinations thereof.

In some embodiments of variants a) or b), the encapsulated oil field chemicals may be substantially homogeneously dispersed throughout the matrix material.

In some embodiments of variants a) or b) the dispersion may be as particles, grains, fragments, or flecks dispersed throughout the matrix material.

In some embodiments of variants a) or b) the dispersion may be homogeneous, and in some instances take the form of a molecular level dispersion approximating that of a solute in solution or like a solid-state solution.

In some embodiments of variant a), a small fraction of the encapsulated oil field chemicals may be exposed at the surface of the matrix encapsulated particles, however the majority of the oil field chemicals are held in the interior of the matrix encapsulated particles.

In some embodiments of variant b) the further layer of matrix material may be the same or different to the matrix material encapsulating the oil field chemicals.

In some embodiments of variants c) and d) the cores are distinct regions, sections or zones within a matrix encapsulated particle.

In some embodiments of variants c) or d) the cores may be liquid.

In some embodiments of variants c) or d) the cores may be aggregates of particles, grains or flecks.

In some embodiments of variants c) or d) the cores may contain liquids comprising suspended solids.

In some embodiments of variant c) the further layer of matrix material may be the same or different to the matrix material encapsulating the cores comprising the oil field chemicals.

In some embodiments the matrix material is substantially insoluble in oil. By “substantially insoluble” it may be meant that less than 10% by weight of matrix material is soluble in oil when the particles are exposed to oil. Preferably less than 5% by weight.

In some preferred embodiments, less than 4%, or less than 3%, or less than 2%, or less than 1% by weight of the matrix material is soluble in oil.

In other embodiments the matrix material is sparingly soluble in oil, preferably insoluble in oil.

In some embodiments less than 3% by weight of the total matrix material is soluble in oil when a 7.4% by weight mixture of matrix material in 92.6% by weight of oil is held at ambient temperature for 18 hours.

Advantageously, the particles are resistant to dissolution in oil and to loss of the chemicals into the oil phase of, for example, a production pipeline, as the matrix material is resistant to dissolution in oil. As a result, oil field chemicals are released predominantly in the water phase to provide optimum treatment of the steel wall of the production pipeline in contact with water.

Other advantages of the presently disclosed particulate compositions include the ability to mix with crude oil or a hydrophobic carrier fluid so that they may be injected into, for example, a production pipeline. Therefore, no additional equipment or infrastructure is required for injection or application in the field.

Further, the encapsulated oil field chemicals may be slowly released into the water phase in the pipeline once the matrix material of the particles slowly degrades or dissolves in water. The slow release of the chemicals into the water phase allows their concentration in the water phase to be maintained at a relatively constant level when the production fluids are traveling through a pipeline and at a much more constant level than possible with traditional treatment using one or more non-encapsulated chemicals. Slow release may also extend the effective treatment period and reduce the need for more frequent treatments. This results in enhanced efficiency and effectiveness of oil field chemicals in, for example, pipeline treatment.

Other advantages of the presently disclosed particulate compositions include one or more of safer handling of the chemicals, simpler equipment required for treatment, reduced costs due to more effective control and lower chemical consumption.

In some embodiments the particles are substantially free of water. By substantially free it may be meant that the particles comprise less than 10% by weight water, or less than 5% by weight, or less than 4% by weight, or less than 3% by weight, or less than 2% by weight, or less than 1% by weight.

In some embodiments, the particles comprise less than 0.5% by weight water, or less than 0.1% by weight water, or are free of water.

In some embodiments the particles are substantially free of solvent.

In some embodiments the matrix material degrades or dissolves in aqueous acid, brine or acidic brine.

The amount of oil field chemicals in the particulate composition may be from about 5% by weight to about 95% by weight based on the total weight of oil field chemicals and matrix material.

Preferably, the amount of oil field chemicals in the particulate composition may be from about 10% by weight to about 90% by weight, or from about 20% by weight to about 80% by weight, or from about 30% by weight to about 50% by weight, based on the total weight of oil field chemicals and matrix material.

In some embodiments the oil field chemicals are selected from the group consisting of corrosion inhibitors, biocides, scale inhibitors, gas hydrate inhibitors, demulsifiers, drag reducing agents and mixtures thereof.

In some embodiments the oil field chemicals comprise a liquid, a solid, a dispersion, such as an emulsion or suspension, and mixtures thereof.

The oil field chemicals may be substantially soluble in water, sparingly soluble in water, or insoluble in water.

The corrosion inhibitor may be selected from commercially available corrosion inhibitor packages used in the art of corrosion protection in oil and/or gas transport and/or storage.

The corrosion inhibitor may comprise one or more surfactants selected from a non-ionic surfactant, an ionic surfactant, an amphoteric surfactant, or mixtures thereof.

The biocide may be selected from one or more biocides used in the art to protect and/or control abiotic corrosion and microbially induced corrosion in oil and/or gas transport and/or storage.

In some embodiments the water degradable, water swellable, or water soluble matrix material is selected from the group consisting of dextran, maltodextrin, gelatin, sugar alcohols such as mannitol, cellulose, methyl cellulose, cellulose ethers, hydroxypropylmethyl cellulose, hydroxypropyl cellulose, hydroxyethyl cellulose, sodium carboxy methyl cellulose, hyaluronic acid, albumin, starch, derivatized starch, chitin, chitosan, polypeptide, protein, carbohydrate, polysaccharide, metaphosphate such as sodium hexametaphosphate, starch, gum acacia, xanthan gum, pectins, carrageenan, guan gum, polyester, poly(ethylene glycol), poly(lactide), poly(glycolide), poly(ε-caprolactone), poly(hydroxy butyrate), polyacrylic acid, polyacrylamide, N-(2-hydroxypropyl)methacrylamide, poly(anhydride), aliphatic poly(carbonate), poly(orthoester), poly(amino acid), poly(ethylene oxide), poly(phosphazene), polyoxazoline, polyphosphate, poly(vinyl alcohol), polyvinyl pyrrolidone, ethylene maleic anhydride copolymer, divinyl ether maleic anhydride copolymer, polyurethanes or polyureas comprising ester linkages, salts, either organic or inorganic, such as, for example, sodium sulphate, calcium carbonate, magnesium sulphate and citrate salts. Combinations of two or more of the disclosed matrix materials may be utilized.

In some preferred embodiments the matrix material is selected from the group consisting of maltodextrin, gelatin, mannitol, methyl cellulose, sodium hexametaphosphate, gum acacia, poly(vinyl alcohol) and ethylene maleic anhydride copolymer.

Other water degradable, water swellable, or water soluble matrix materials may be suitable and the herein disclosed materials should not be considered an exhaustive list.

In some embodiments the density of at least some of the particles is greater that the density of water or greater than the density of brine.

The density of the particles may be greater than 1.00 g/cm³, or greater than 1.05 g/cm³, or greater than 1.10 g/cm³, or greater than 1.15 g/cm³, or greater than 1.20 g/cm³.

In some embodiments the density of the particles may be between about 1.00 g/cm³ and about 3.00 g/cm³ or between about 1.05 g/cm³ and about 2.00 g/cm³, or between about 1.15 g/cm³ and about 2.00 g/cm³.

In some preferred embodiments the density of the particles may be adjusted to be higher than the density of crude oil and/or water by encapsulating further solids or liquids in the particles, so that, in use, they sink to the bottom of a production pipeline.

In some embodiments the particles may comprise one or more further solid or liquid materials. The one or more solid materials may be matrix encapsulated by the matrix material.

In some embodiments the particles comprise a further material which has a higher density than water or brine. The particles may comprise a further solid or liquid which is miscible with water.

Typically, light crude oil has a density less than 0.87 g/cm³, medium crude oil a density from 0.87 to 0.92 g/cm³, heavy crude oil a density from 0.92 to 1.00 g/cm³ and extra-heavy crude oil a density greater than 1.00 g/cm³

In some embodiments the particles comprise one or more further solid or liquid components having a higher density than water or brine.

In some embodiments the density of the one or more further solid or liquid components may be greater than 1.00 g/cm³, or greater than 1.05 g/cm³, or greater than 1.10 g/cm³, or greater than 1.15 g/cm³, or greater than 1.20 g/cm³.

The density of the one or more further solid or liquid components may be between about 1.00 g/cm³ and about 3.0 g/cm³.

In some embodiments the particles comprise one or more further liquid components which are miscible with water. This is advantageous as after the matrix material degrades or dissolves and the chemicals delivered to an aqueous phase, the further liquid component is soluble in the aqueous phase.

In some embodiments the particles comprise one or more further liquid components having both a higher density than water and miscibility with water.

Examples of suitable liquids include polyols such as ethylene glycol, diethylene glycol and glycerol.

In some embodiments the particles comprise one or more further solid components having both a higher density than water and miscibility with water.

Examples of suitable solid components include alkali metal salts, alkaline earth salts and ammonium salts. Non-limiting examples of salts include sodium chloride, sodium bromide, sodium iodide, magnesium chloride, calcium chloride, sodium sulphate, potassium nitrate, and ammonium chloride.

Accordingly, by varying the amount and nature of the further solid and/or liquid components in the particles, the density of the particles may be adjusted.

In some embodiments the matrix material may substantially dissolve in water. This is particularly advantageous as substantially no residual matrix material shards may remain which otherwise may contribute to fouling or even blockages in transport systems, such as pipelines.

In some embodiments the matrix material may substantially dissolve in acidic water, or brine, or acidic brine.

In some embodiments the particles migrate to a water/metal interface of a vessel within which the multiphase environment resides.

In some embodiments the particles are about 10 nm to about 1 mm in size, or about 100 nm to about 500 micron, or about 1 micron to about 250 micron, or about 1 micron to about 100 micron.

In some embodiments the matrix material comprises a water soluble, water swellable, or water degradable material. In some embodiments the matrix substantially dissolves in water over time.

The rate of degradation or dissolution of the matrix material may increase with decreasing pH.

The size of the particles may influence the rate of degradation or dissolution in an aqueous environment. Additionally, the concentration of oil field chemicals in the particles may be varied. Adjusting particle size and/or oil field chemical concentration allows control of the released oil field chemicals into an aqueous environment so as to achieve target concentrations.

In some embodiments a first fraction of particles comprises a first set of one or more oil field chemicals and a second set of particles comprise a second set of oil field chemicals.

Such arrangements may be advantageous if certain chemical components are non-compatible. In this way, flexible storage and eventual delivery of active chemical components may be achieved.

In some embodiments a first fraction of particles comprise one or more biocides, and a second fraction of particles comprise one or more different biocides.

In some embodiments at least a first fraction of particles comprise one or more corrosion inhibitors and at least a second fraction of particles comprise one or more biocides.

For example, in one embodiment, the particulate composition may comprise a mixture of particle fractions wherein a first fraction comprises a first scale inhibitor, a second fraction comprises a second scale inhibitor, and a third fraction comprises a corrosion inhibitor and a fourth fraction a biocide.

It will be evident to the person of ordinary skill that numerous other combinations of oil and gas field chemicals may be present in separate fractions of the particulate composition. The choice and number of the chemicals will be dependent on the required treatment in any given scenario.

In any one or more of the herein disclosed aspects the matrix materials may be engineered so as to control the release of the oil field chemicals. For example, the matrix material may be engineered to rapidly degrade and/or dissolve in water and/or acidic water, or brine and/or acidic brine so as to quickly release the chemical components. In other examples, the matrix material may be engineered to more slowly degrade and/or dissolve in water and/or acidic water or brine and/or acidic brine so as to release the chemical components over an extended period of time.

In any one or more of the herein disclosed aspects the matrix may comprise materials that degrade or dissolve in aqueous environments, such as aqueous acidic, brine or acidic brine environments.

In some embodiments the particles may comprise a first fraction of particles comprising matrix material engineered to quickly degrade and/or dissolve in water and a second fraction of particles comprising matrix material engineered to more slowly degrade and/or dissolve in water.

The first and second fractions may comprise the same or different chemical components.

For example, a first fraction of particles may comprise a corrosion inhibitor and comprise a matrix material designed to degrade quickly in water, whereas a second fraction of particles may comprise a biocide and comprise a matrix material designed to degrade more slowly. Accordingly, time controlled delivery of particular chemical components may be achieved.

In another aspect the present disclosure provides a method of delivering oil field chemicals to an oil or gas facility comprising the steps of:

introducing one or more particulate compositions to the oil or gas facility, said particulate composition comprising a plurality of particles, said particles comprising a water soluble, water swellable, or water degradable matrix material and one or more oil field chemicals; said particles having a morphology selected from;

a) matrix encapsulated; and

b) core-shell encapsulated; and

allowing the oil field chemicals to be released from the particles.

In some embodiments the oil or gas facility comprises a multiphase environment, for example an oil/water or gas/water environment.

In another aspect the present disclosure provides a method of delivering oil field chemicals to a water phase of a multiphase environment comprising the steps of:

introducing one or more particulate compositions to a multiphase environment, said particulate composition comprising a plurality of particles, said particles comprising a water soluble, water swellable, or water degradable matrix material and one or more oil field chemicals; said particles having a morphology selected from;

a) matrix encapsulated; and

b) core-shell encapsulated;

allowing the particles to migrate to the water phase; and
allowing the oil field chemicals to be released from the particles into the water phase.

In another aspect the present disclosure provides a method of delivering oil field chemicals to a water/vessel wall interface of a multiphase environment comprising the steps of: introducing one or more particulate compositions to a multiphase environment, said particulate composition comprising a plurality of particles, said particles comprising a water soluble, water swellable, or water degradable matrix material and one or more oil field chemicals; said particles having a morphology selected from;

a) matrix encapsulated; and

b) core-shell encapsulated;

allowing the particles to migrate to the water/vessel wall interface; and
allowing the oil field chemicals to be released from the particles into the water phase.

In any one of the delivery methods herein disclosed the multiphase environment is an oil and water environment.

In any one of the delivery methods herein disclosed the water is production water from an oil well.

In any one of the delivery methods herein disclosed the oil is crude oil from an oil well.

In any one of the delivery methods herein disclosed the water may have a pH less than 7.0, or less than 6.0, or less than 5.0, or less than 4.0.

In any one of the delivery methods herein disclosed between 10% and 90% by weight of the oil field chemicals present in the particulate compositions may be released into the water phase. In some embodiments, between 10% and 60%, or between 20% and 40% by weight of the oil field chemicals present in the particulate compositions may be released into the water phase.

In other embodiments more than 10%, or more than 20%, or more than 30%, or more than 40%, or more than 50% by weight of the oil field chemicals present in the particulate compositions may be released into the water phase.

In alternate embodiments more than 70%, or more than 80%, or more than 90% by weight of the oil field chemicals present in the particulate compositions may be released into the water phase.

In any one of the herein disclosed methods, when placed in service the particulate compositions are exposed to water. Service may be, for example, in a pipeline, process vessel, or equipment containing corrodible metal alloys.

In any one of the herein disclosed methods the matrix material may degrade, dissolve, or swell so as to release at least some of the encapsulated oil field chemicals within 24 hours or less after being-placed in service, or within 5 hours. or less, or within 30 minutes or less, or within 5 minutes or less.

In any one of the herein disclosed methods, at least a portion of the matrix (either core shell or matrix encapsulated morphologies) materials degrade, dissolve, or swell and continue releasing oil field chemicals for at least 0.1 hours, or at least 1 hour, or at least 10 hours, or at least 100 hours after being placed in service. It is preferable that at least 10% of oil field chemicals contained in the encapsulated chemicals (either core shell or matrix encapsulated morphologies) be released after 0.1 hour, or 1 hour, or 10 hours or 100 hours after being placed in service.

In any one of the herein disclosed methods, when the service is mitigation of corrosion in a pipeline, at least 10%, or at least 1%, or at least 0.1%, or at least 0.01% of the oil field chemicals should, preferably, arrive at the end of the pipeline or to a point where another application of the particulate composition may be made.

In any one of the delivery methods herein disclosed the particulate composition may be introduced to the facility or multiphase environment as a mixture in a carrier fluid such as crude oil or hydrophobic fluid.

The carrier fluid is preferably an inert fluid which does not degrade or dissolve the matrix material or cause it to deteriorate. An oil based fluid will be particularly desirable, such as a hydrocarbon oil. For example, a hydrocarbon fluid such as kerosene is particularly suitable. Other hydrocarbon fluids like diesel fuel can be used. Other aliphatic or aromatic fluids, including mixtures thereof, are useful in certain applications. Exemplary aromatic hydrocarbons include toluene and xylene.

Numerous methods may be utilized to prepare the particulate compositions of the present disclosure. For example, spray drying, coextrusion (including stationary, vibrating nozzle, centrifugal, electrohydrodynamic, nanoencapsulation), coating (including fluid bed and pan), polymerization (including in-situ and interfacial), solvent evaporation, phase separation, coacervation, sol-gel methods, liposome formation, polymer membrane, and so forth.

The particulate compositions may be prepared using batch, continuous or combination of batch and continuous methods.

In another aspect of the present disclosure there is provided a method of preparing a particulate composition, said particulate composition comprising a plurality of particles, said particles comprising a water degradable, water swellable, or water soluble matrix material and one or more oil field chemicals matrix encapsulated therein, the method comprising the step of spray drying a mixture of one or more matrix materials and one or more oil field chemicals.

In another aspect of the present disclosure there is provided a method of preparing a particulate composition, said particulate composition comprising a plurality of particles, said particles comprising a water degradable, water swellable, or water soluble matrix material and one or more oil field chemicals matrix encapsulated therein, the method comprising the step of atomizing a mixture of one or more matrix materials and one or more oil field chemicals.

In another aspect of the present disclosure there is provided a method of preparing a particulate composition, said particulate composition comprising a plurality of particles, said particles comprising a water degradable, water swellable, or water soluble matrix material and one or more oil field chemicals matrix encapsulated therein, the method comprising the step of spray chilling a mixture of one or more matrix materials and one or more oil field chemicals.

In another aspect of the present disclosure there is provided a method of preparing a particulate composition, said particulate composition comprising a plurality of particles, said particles comprising a water degradable, water swellable, or water soluble matrix material and one or more oil field chemicals matrix encapsulated therein, the method comprising the step of coacervating or precipitating a mixture of one or more matrix materials and one or more oil field chemicals.

In another aspect of the present disclosure there is provided a method of preparing a particulate composition, said particulate composition comprising a plurality of particles, said particles comprising a water degradable. water swellable, or water soluble matrix material and one or more oil field chemicals encapsulated therein, the method comprising the step of co-extruding a mixture of one or more matrix materials and one or more oil field chemicals.

Co-extrusion may result in a core comprising one or more oil field chemicals and a shell comprising one or more water degradable, water swellable, or water soluble materials.

The results presented herein clearly demonstrate the advantage of the presently disclosed particulate compositions in delivering corrosion inhibitors to the water phase of an oil/water multiphase environment. The person of ordinary skill in the art would readily appreciate that the presently disclosed particulate compositions may comprise a wide range of chemicals encapsulated within the matrix materials and that these chemicals may be delivered to the water phase of an oil/water multiphase environment.

Further features and advantages of the present disclosure will be understood by reference to the following drawings and detailed description.

### BRIEF DESCRIPTION OF THE DRAWINGS

FIG. 1 illustrates particles having different morphologies according to embodiments of the present disclosure.

FIG. 2 is a particle size distribution of a particulate composition according to one embodiment of the present disclosure.

FIG. 3 is a particle size distribution of a particulate composition according to one embodiment of the present disclosure.

FIG. 4 is an electron micrograph of a particulate composition according to one embodiment of the present disclosure.

FIG. 5 is an electron micrograph of a particulate composition according to one embodiment of the present disclosure.

FIG. 6 is a chart illustrating the partitioning behavior of a particulate composition according to one embodiment of the present disclosure as compared to the neat corrosion inhibitor package.

FIG. 7 is a chart illustrating the corrosion inhibition performance of a particulate composition according to one embodiment of the present disclosure as compared to the neat corrosion inhibitor package and neat matrix material.

FIG. 8 is a chart comparing the inhibition performance of a particulate composition according to one embodiment of the present disclosure with neat corrosion inhibitor.

FIG. 9 is a chart comparing the inhibition performance of a particulate composition according to one embodiment of the present disclosure with neat corrosion inhibitor.

FIG. 10 shows examples of demulsification bottle tests including various types of corrosion inhibitors.

FIG. 11 shows additional examples of demulsification bottle tests.

FIG. 12 shows dehydration ratios over time for the demulsification bottle tests shown in FIG. 11.

### DETAILED DESCRIPTION OF THE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any compositions, methods and materials similar or equivalent to those described herein can also be used in the practice or testing of the present disclosure, the preferred compositions, methods and materials are now described.

It must also be noted that, as used in the specification and the appended claims, the singular forms ‘a’, ‘an’ and ‘the’ include plural referents unless otherwise specified. Thus, for example, reference to ‘corrosion inhibitor’ may include more than one corrosion inhibitor, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless specifically stated or obvious from context, as used herein, the term ‘about’ is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any methods provided herein can be combined with one or more of any of the other methods provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N.Y., 2001.

### Matrix Encapsulated Particulate Compositions

In some embodiments the present disclosure provides compositions, methods of manufacture and use of a plurality of particles that may have a distribution of sizes and that may be added or injected into, for example, pipelines, process vessels and other types of process equipment to prevent or mitigate fouling, corrosion, and/or to promote flowability of fluids. The term plurality is taken to mean more than 10, or more than 100, or more than 1,000, or more than 10,000, or more than 100,000 particles. Particles are used to deliver oil field chemicals into pipelines, process, vessels, or other types of process equipment to mitigate or prevent fouling, corrosion and/or to promote flowability of fluids. In a preferred embodiment the vessels contain fluids that are multiphase with at least one phase being a water phase. Examples of other phases are gases and liquids (such as oil).

When placed in service, a plurality of particles is injected or added into the pipeline, process vessel or process equipment, as either a powder or a suspension carried in a liquid or gas medium. For example a plurality of particles may be placed in service by mixing with crude oil or a hydrophobic carrier fluid and injected into, for example, a pipeline, a process vessel or process equipment. This type of equipment comprises oil or gas field facilities. Once in service, the plurality of particles contacts a water phase and releases oil field chemicals that, for example, prevent or mitigate fouling or corrosion and/or promote flowability of fluids.

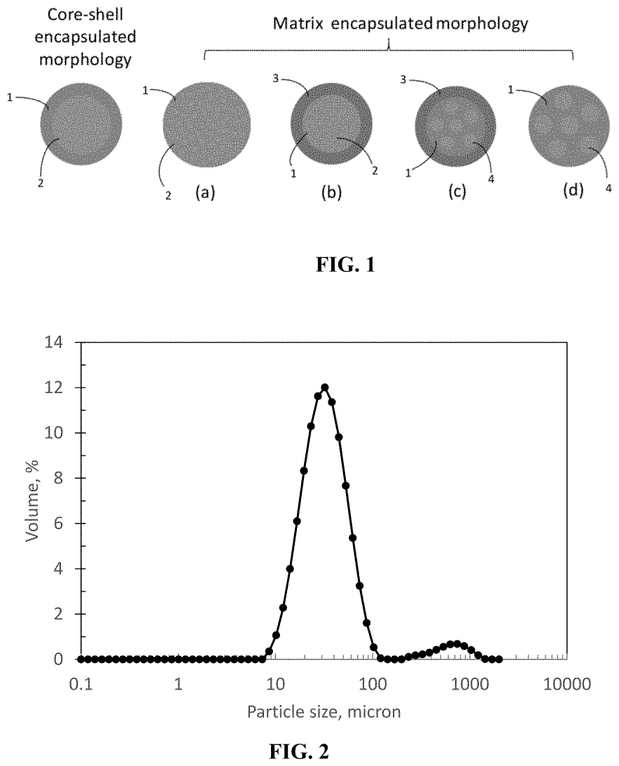

Oil or gas field chemicals, are, for example, corrosion inhibitors, biocides, drag reducing agents, demulsifiers, and scale inhibitors. These oil or gas field chemicals are encapsulated within the plurality of particles. There are two very different morphologies for encapsulated particles. The first is a core-shell architecture in which a single layer of matrix material surrounds the oil or gas field chemicals forming microcapsules. The second is a matrix encapsulated particle containing oil or gas field chemicals. Referring to FIG. 1, matrix encapsulated morphology may be selected from particles comprising, a) matrix material (1) comprising encapsulated oil field chemicals (2), said oil field chemicals being dispersed throughout the matrix material, b) matrix material (1) comprising encapsulated oil field chemicals (2), said oil field chemicals being dispersed throughout the matrix material, said matrix material being surrounded by a further layer of matrix material (3) absent oil field chemicals, c) multiple cores comprising oil field chemicals (4), said cores being encapsulated by matrix material (1), said matrix material being surrounded by a further layer of matrix material (3) absent oil field chemicals, d) multiple cores comprising oil field chemicals (4), said cores being encapsulated by matrix material (1), and combinations thereof.

In some embodiments of variants a) or b), the encapsulated oil field chemicals may be substantially homogeneously dispersed throughout the matrix material.

In some embodiments of variants a) or b) the dispersion may be as particles, grains, fragments, or flecks dispersed throughout the matrix material.

In some embodiments of variants a) or b) the dispersion may be homogeneous, and in some instances take the form of a molecular level dispersion approximating that of a solute in solution or like a solid-state solution.

In some embodiments of variant a), a small fraction of the encapsulated oil field chemicals may be exposed at the surface of the matrix encapsulated particles, however the majority of the oil field chemicals are held in the interior of the matrix encapsulated particles.

In some embodiments of variant b) the further layer of matrix material may be the same or different to the matrix material encapsulating the oil field chemicals.

In some embodiments of variants c) and d) the cores are distinct regions, sections or zones within a matrix encapsulated particle.

In some embodiments of variants c) or d) the cores may be liquid.

In some embodiments of variants c) or d) the cores may be aggregates of particles, grains or flecks.

In some embodiments of variants c) or d) the cores may contain liquids comprising suspended solids.

In some embodiments of variant c) the further layer of matrix material may be the same or different to the matrix material encapsulating the cores comprising the oil field chemicals.

As such, the morphology of the matrix encapsulated materials differs from that of a core-shell microcapsule. In both cases it is preferred that the matrix material is either a water degradable, water swellable, or a water soluble material. As the encapsulating particle degrades, swells or solubilizes the oil field chemicals are released. Matrix encapsulated materials provide a unique composition of matter that advantageously mitigates corrosion and/or fouling mitigation and/or improves flow assurance.

### Matrix Materials

The matrix materials of the present disclosure are preferably made from a water degradable material, water swellable, or water soluble material that degrades, swells, or solubilizes when subjected to an aqueous environment so as to release the chemical components that are encapsulated by the matrix into the aqueous phase. Control of the material properties of the matrix allows engineering and control of the rate at which chemical components are released.

For the case in which the matrix material dissolves forming a solution in the aqueous phase, the matrix encapsulated chemical components are primarily convectively transported away with some diffusional contribution to the transport rate. The rate of release is primarily determined by the rate at which particles dissolve. Non-limiting examples of material properties that can govern the rate at which a particle with a polymeric matrix dissolves include particle size, chemical composition, molecular weight distribution, and the way polymer chains are intertwined, ordered, or packed together. Control of these properties allows engineering of the rate at which chemical components are released for soluble matrix encapsulated particles.

For the case in which the matrix material swells, the matrix encapsulated chemical components are primarily transported by diffusion into the aqueous phase. In this case the rate of release is primarily determined by the transport diffusivity of the chemical components in the swollen matrix. Non-limiting examples of material properties that can govern the rate chemical components are diffusionally transported through a swellable polymeric matrix include particle size, chemical composition, molecular weight distribution, polymer crosslinking, and polymer crosslink density. Control of these properties allows engineering of the rate at which chemical components are released for swellable matrix encapsulated particles.

For the case in which the matrix material degrades, the encapsulated chemical components are released through a combination of diffusion and convective transport processes that deliver the matrix encapsulated chemical components into the aqueous phase. In this case the rate of release is primarily determined by the nature of the degradation process. In some cases the degradation can be a chemical degradation of the matrix materials while in another case the degradation can be a physical extraction of a portion of the matrix material. Non-limiting examples of extractable polymer matrix materials include water soluble polymers with a small or modest fraction of crosslinked chains that do not solubilize, or a polymer with a very high molecular weight fraction that does not readily go into solution. Physical mixtures of water soluble and water insoluble polymers will in most cases be matrix materials that undergo a degradation process. Material properties that can govern the rate of release from degradable polymeric matrix materials include particle size, chemical composition, molecular weight distribution, polymer crosslinking, and polymer crosslink density. Control of these properties allows engineering of the rate at which chemical components are released for degradable matrix encapsulated particles. In addition composite structures that have a water soluble matrix material over-coated with a water insoluble material will also fall into the class of matrix materials that degrades.

Such water degradable, water swellable, or water soluble matrix materials include a wide variety of polymers. One of ordinary skill in the art will be able to determine the appropriate degradable, swellable, or soluble material to achieve the desired degradation, swelling or solubility in a particular environment.

Suitable examples of degradable, swellable, or soluble matrix materials include, but are not limited to, dextran, maltodextrin, gelatin, sugar alcohols such as mannitol, cellulose, methyl cellulose, cellulose ethers, hydroxypropylmethyl cellulose, hydroxypropyl cellulose, hydroxyethyl cellulose, sodium carboxy methyl cellulose, hyaluronic acid, albumin, starch, derivatized starch, chitin, chitosan, polypeptide, protein, carbohydrate, polysaccharide, metaphosphate such as sodium hexametaphosphate, starch, gum acacia, xanthan gum, pectins, carrageenan, guan gum, polyester, poly(ethylene glycol), poly(lactide), poly(glycolide), poly(ε-caprolactone), poly(hydroxy butyrate), polyacrylic acid, polyacrylamide, N-(2-hydroxypropyl)methacrylamide, poly(anhydride), aliphatic poly(carbonate), poly(orthoester), poly(amino acid), poly(ethylene oxide), poly(phosphazene), polyoxazoline, polyphosphate, poly(vinyl alcohol), polyvinyl pyrrolidone, ethylene maleic anhydride copolymer, divinyl ether maleic anhydride copolymer, polyurethanes or polyureas comprising ester linkages, salts, either organic or inorganic, such as, for example, sodium sulphate, calcium carbonate, magnesium sulphate and citrate salts. Combinations of two or more of the disclosed matrix materials may be utilized.

In some preferred embodiments the matrix material is selected from the group consisting of maltodextrin, gelatin, mannitol, methyl cellulose, sodium hexametaphosphate, gum acacia, poly(vinyl alcohol) and ethylene maleic anhydride copolymer.

In some embodiments, the particles may be coated with coatings which may impart a degree of resistance, if desired, to the particles water solubility. This may be desirable when a delay period is beneficial before the chemical components contained within matrix material are released

In other embodiments, the matrix material may be crosslinked so as to control, preferably slow down, the rate of matrix degradation or dissolution. This may delay the release of the oil field chemicals.

Similarly, it is possible to provide for the release of different chemical components in different particles of a system under different conditions, for instance, different temperatures or at different pHs. In one embodiment, different matrix materials may be used to facilitate the delivery of a first chemical component to one area of a pipeline and the delivery of a second chemical component to a second area of a pipeline.

### Oil Field Chemicals

As used herein the term “oil field chemicals” encompasses any chemical or mixtures of chemicals used in the oil and gas industry, including without limitation:

(1) corrosion inhibitors which prevent the corrosive attack on metals in oil and gas production equipment, For example, fatty amine salts, amido amines, imidazolines, diamine salts, polar organic compounds and quaternary ammonium compounds, e.g., cationic surfactants.
(2) dispersants which act as solubilizing agents for paraffin, e.g., nonionic and anionic surfactants.
(3) pour point modifiers (e.g. wax inhibitor) to inhibit the deposition of paraffinic material in, for example, well tubing and moving parts of equipment; typically long chain polymers and/or surface active materials.
(4) emulsion breaking chemicals which hasten the separation of produced water from crude oil, such as, phenol formaldehyde sulfonate, alkylphenol ethoxylates, diepoxides, sulfonates, resin esters, and polyglycols.
(5) acids or acid salts. For example, formic acid and sulfamic acid used for the dissolution of calcium carbonate-containing formations.
(6) scale inhibitors for preventing the deposition of scale in a wellbore and formation. For example, phosphonates, polyacrylates and phosphate esters.
(7) bactericides, for example quaternary ammonium compounds and aldehydes, such as coconut alkyl trimethylammonium salts and glutaraldehyde.
(8) asphaltene treatment chemicals (asphalt dispersant), such as alkylphenol ethoxylates and aliphatic poly ethers.

### Corrosion Inhibitor

The corrosion inhibitor may be selected from commercially available corrosion inhibitor packages used in the art of corrosion protection in oil and/or gas transport and/or storage.

The corrosion inhibitor may comprise one or more surfactants selected from a non-ionic surfactant, an ionic surfactant, an amphoteric surfactant, or mixtures thereof.

As used herein, a “nonionic surfactant” refers to a surfactant in which the molecules forming the surfactant are uncharged. Suitable nonionic surfactant include, but are not limited to, condensation products of ethylene oxide with phenols, naphthols, and alkyl phenols, for example octyphenoxy-nonaoxyethyleneethanol. Examples of nonionic surfactants include, but are not limited to, ethylene glycol monostearate, propylene glycol myristate, glyceryl monostearate, glyceryl stearate, polyglyceryl-4-oleate, sorbitan acylate, sucrose acylate, PEG-150 laurate, PEG-400 monolaurate, polyoxyethylene monolaurate, polysorbates, polyoxyethylene octylphenylether, PEG-1000 cetyl ether, polyoxyethylene tridecyl ether, polypropylene glycol butyl ether, stearoyl monoisopropanolamide, and polyoxyethylene hydrogenated tallow amide. Other examples of nonionic surfactants include, but are not limited to, fatty acid glycerine esters, sorbitan fatty acid esters, sucrose fatty acid esters, polyglycerine fatty acid esters, higher alcohol ethylene oxide adducts, single long chain polyoxyethylene alkyl ethers, polyoxyethylene alkyl allyl ethers, polyoxyethylene lanolin alcohol, polyoxyethylene fatty acid esters, polyoxyethylene glycerine fatty acid esters, polyoxyethylene propylene glycol fatty acid esters, polyoxyethylene sorbitol fatty acid esters, polyoxyethylene castor oil or hardened castor oil derivatives, polyoxyethylene lanolin derivatives, polyoxyethylene fatty acid amides, polyoxyethylene alkyl amines, an alkylpyrrolidone, glucamides, alkylpolyglucosides, mono- and dialkanol amides, a polyoxyethylene alcohol mono- or diamides and alkylamine oxides.

As used herein, an “ionic surfactant” refers to a surfactant in which the molecules forming the surfactant are charged. Suitable ionic surfactants include, but are not limited to, sulfonates, sulfates, ammonium, phosphonium, and sulphonium alkylated quaternary or ternary compounds, singly or attached to polymeric compounds. Suitable anionic surfactants include, but are not limited to, those containing carboxylate, sulfonate, and sulfate ions. Examples of anionic surfactants include, but are not limited to, sodium, potassium, ammonium of long chain alkyl sulfonates and alkyl aryl sulfonates such as sodium dodecylbenzene sulfonate; dialkyl sodium sulfosuccinates, such as sodium dodecylbenzene sulfonate; dialkyl sodium sulfosuccinates, such as sodium bis-(2-ethylthioxyl)-sulfosuccinate; and alkyl sulfates such as sodium lauryl sulfate. Cationic surfactants include, but are not limited to, imidazoline and derivatives, fatty amines, polyamines, aromatic amines, quaternary ammonium compounds such as benzalkonium chloride, benzethonium chloride, cetrimonium bromide, stearyl dimethylbenzyl ammonium chloride, polyoxyethylene (15), and coconut amine. Examples of the anionic surfactants include, but are not limited to, fatty acid soaps, ether carboxylic acids and salts thereof, alkane sulfonate salts, α-olefin sulfonate salts, sulfonate salts of higher fatty acid esters, higher alcohol sulfate ester salts, fatty alcohol ether sulfates salts, higher alcohol phosphate ester salts, fatty alcohol ether phosphate ester salts, condensates of higher fatty acids and amino acids, and collagen hydrolysate derivatives. Examples of the cationic surfactants include, but are not limited to, alkyltrimethylammonium salts, dialkyldimethylammonium salts, alkyldimethylbenzylammonium salts, alkylpyridinium salts, alkylisoquinolinium salts, benzethonium chloride, and acylamino acid type cationic surfactants.

As used herein, an “amphoteric surfactant” refers to a surfactant compound uniquely structured to function as cationic surfactants at acid pH and anionic surfactants at alkaline pH. Suitable amphoteric surfactants include, but are not limited to, amino acid, betaine, sultaine, phosphobetaines, and imidazoline type amphoteric surfactants. Examples for amphoteric surfactants include, but are not limited to, sodium N-dodecyl-beta-alanine, sodium N-lauryl-beta-iminodipropionate, myristoamphoacetate, lauryl betaine, and laurylsulfobetaine.

### Biocides

As used herein, the term “biocide” refers to agents such as germicides, bactericides, disinfectants, sterilizers, preservatives, fungicides, algicides, aquaticides, herbicides and the like, each of which may be used for their ability to inhibit growth of and/or destroy various biological and/or microbiological species such as bacteria, fungi, algae and the like.

Examples of suitable biocides may include both so-called non-oxidizing and oxidizing biocides. Examples of commonly available oxidizing biocides include hypochlorite bleach, such as calcium hypochlorite and lithium hypochlorite, peracetic acid, potassium monopersulfate, potassium peroxymonosulfate, bromochlorodimethylhydantoin, dichloroethylmethylhydantoin, chloroisocyanurate, trichloroisocyanuric acids and dichloroisocyanuric acids and salts thereof, or chlorinated hydantoins. Suitable oxidizing biocides may also include, for example bromine products such as stabilized sodium hypobromite, activated sodium bromide, or brominated hydantoins. Suitable oxidizing biocides may also include, for example chlorine dioxide, ozone, inorganic persulfates such as ammonium persulfate, or peroxides, such as hydrogen peroxide and organic peroxides.

Examples of non-oxidizing biocides include quaternary ammonium salts, aldehydes and quaternary phosphonium salts.

Examples of aldehydes include formaldehyde, glyoxal, furfural, acrolein, methacrolein, propionaldehyde, acetaldehyde, crotonaldehyde and mixtures thereof. Examples of quaternary ammonium salts include pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, methylbenzethonium chloride, myristyl-gamma-picolinium chloride, ortaphonium chloride, triclobisonium chloride, alkyl dimethyl benzyl ammonium chloride, cocodiamine, and mixtures thereof.

Examples of phosphonium salts include, for example, tributyltetradecyl phosphonium chloride.

Other examples of commonly available non-oxidizing biocides may include dibromonitfilopropionamide, thiocyanomethylthiobenzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl)phosphonium sulfate, glutaraldehyde, alkyldimethylbenzyl ammonium chloride, didecyldimethylammonium chloride, poly[oxyethylene-(dimethyliminio)ethylene(dimethyliminio)ethylene dichloride], decylthioethanamine, and terbuthylazine.

Other examples of non-oxidizing biocides may include isothiazolinone biocides such as, for example, 5-chloro-2-methyl-4-isothiazolin-3-one, 2-methyl-4-isothiazolin-3-one, and 1,2-benzisothiazolin-3-one and combinations thereof.

Additional examples of non-oxidizing biocides may include, for example, 2-bromo-2-nitro-1,3-propanediol, 2-2-dibromo-3-nitrilopropionamide, tris(hydroxymethyl)nitromethane, 5-bromo-5-nitro-1,3-dioxane and sulfur compounds, such as, for example, isothiazolone, carbamates, and metronidazole.

Additional examples of oxidizing and non-oxidizing biocides include triazines such as 1,3,5-tris-(2-hydroxyethyl)-s-triazine and trimethyl-1,3,5-triazine-1,3,5-triethanol.

### Use of Matrix Encapsulated Particles

Matrix encapsulated oil field chemicals can be used, for example, to mitigate corrosion, or mitigate fouling and/or to improve flowability in pipelines, and/or process vessels, and/or process equipment through which there is multiphase flow. They can be used for any of the multitude of multiphase flow structures, examples of which are fully turbulent, churning, slugging, dispersed, annular and laminar. After being introduced into either a pipeline, process vessel, or process equipment they are carried by the flow and begin to release chemicals which mitigate corrosion, and/or mitigate fouling and/or improve flowability.

Introduction of matrix encapsulated particles into a pipeline, process vessel, or process equipment is referred to as placing them in service. When placed in service, particles are injected or added to the multiphase flow equipment as either a powder, a suspension or carried in a liquid or gas medium. Injection or addition rates can be constant or transient, for example time varying pulsed or periodic injections can be used. Different particles carrying different chemicals can be injected simultaneously or sequentially. For example it is possible to use a combination of matrix encapsulated particles containing different chemicals, different types of matrix encapsulated particles, a combination of matrix encapsulated particles and core shell microcapsules containing oil field chemicals, as well as matrix encapsulated particles and non-encapsulated oil field chemicals.

During the times the matrix encapsulated particles are injected, the volume fraction of particles injected should be less than 10% of the volume of liquid that passes by the injection or addition point, or less than 1%, or less than 0.1%, or less than 0.01%, or less than 0.001% of the volume of liquid that passes by the injection or addition point. In a preferred embodiment the chemicals are released directly into the water phase as the particles are carried by the multiphase flow. This doses the interior of the pipeline, process vessel or process equipment in the places where fouling and/or corrosion are most likely to occur with the oil field chemicals thus improving their effectiveness. It also enables oil field chemicals previously considered unsuitable to be considered for use. It also enables the use of different oil field chemical combinations that otherwise may be antagonistic when combined in their neat state.

To provide mitigation of corrosion, or fouling and/or to improve flowability near the injection point it is desired that they begin to release oil field chemicals shortly after injection. In particular, matrix encapsulated particles should release at least some of the encapsulated oil field chemicals within 24 hours or less, or within 5 hours or less, or within 30 minutes or less, or within 20 minutes or less, or within 10 minutes or less, or within 5 minutes or less, after being placed in service and exposed to water.

Desirably, the matrix encapsulated particles continue to release chemicals as they are carried to the end of the pipeline or to a point on the pipeline where more matrix encapsulated particles can be added. This places a requirement that a fraction of particles have a slow release rate that allows the concentration of released chemicals to be relatively constant as they are carried along by the flow. To meet this requirement at least a portion of the encapsulated (either core shell or matrix morphologies) materials degrade, dissolve, or swell and continue releasing oil field chemicals for at least 0.1 hours, or at least 1 hour, or at least 10 hours, or at least 100 hours after being placed in service. In some embodiments, 10% of oil field chemicals contained in the encapsulated material (either core shell or matrix morphologies) may be released after 0.1 hours, or after 1 hour, or after 10 hours, or after 100 hours. Similarly, it is preferable that at least 10%, or at least 1%, or at least 0.1%, or at least 0.01% of the oil field chemicals injected with the matrix encapsulated particles should arrive at the end of the pipeline or to a point where another application of the encapsulated materials can be made.

To efficiently deliver the oil field chemicals it is desirable that the matrix encapsulated particles contain oil field chemicals from about 5% to about 95% by weight based on the total weight of the oil field chemicals and the matrix material. In other embodiments the amount of oil field chemicals in the particulate composition can range from 10% to 80% by weight, or from 20% to about 70% by weight, based on the total weight of the oil field chemicals and the matrix material.

### EXAMPLES

### Example 1: Preparation of Particulate Compositions Comprising Corrosion Inhibitors

Two commercially available corrosion inhibitor packages were evaluated. Corrtreat 3747 (Clariant) and EC1625A (Nalco™). Details of various matrix materials tested are listed in Table 1. All matrix materials were soluble in water and were used as received.

TABLE 1

| Matrix Material | Grade | Supplier |
|---|---|---|
| Maltodextrin | Maltrin M100 | Grain Processing |
| | | Corporation, Iowa |
| Gelatin, porcine | 300 Bloom, 40 mesh | Custom Collagen, Illinois |
| D-mannitol | | Sigma-Aldrich |
| Methyl cellulose | SG A150 | Dow Chemical |
| Sodium | | Calgon |
| hexametaphosphate | | |
| Gum acacia | | Spectrum |
| Fish gelatin | HMWD | Kenny & Ross |
| Starch | HiCap 100 | Ingredion |
| Poly(vinyl alcohol) | 80% hydrolyzed | Sigma-Aldrich |
| ZeMac ™ | E60 (ethylene/maleic | Vertellus |
| | anhydride copolymer) | |

The corrosion inhibitors were combined with the matrix materials and the resulting mixtures spray dried. Formulations and spray drying conditions are summarized in Table 2A. Mixtures were prepared by dissolving the matrix material in water, followed by dispersion of the corrosion inhibitor. The exception was sample P36, which was formulated with methanol. The mixtures were spray dried using a ProCepT 4M8 laboratory spray dryer. The mixture was atomized using a 0.4 mm bifluid nozzle with a nozzle pressure of 3.1 bar, fed at a rate of approximately 5-6 g/min. Air speed for all runs was set to 0.3 m³/min. The air inlet, chamber, and outlet temperatures are included in Table 2A. These were varied based on the material and objective of the particular run. For example, most aqueous formulations were spray dried with an inlet temperature of 160-170° C. to adequately remove water. One of the gelatin formulations, P12, and the formulation in methanol, P36, were spray dried at lower temperatures in an effort to preserve any volatiles carried over from the corrosion inhibitor formulations. The solutions prepared with porcine gelatin were heated to, and maintained at, 50° C. to prevent gelation.

TABLE 2A

| | | Matrix | | | | Added | | | |
|---|---|---|---|---|---|---|---|---|---|
| | Matrix | material | | CI | | excipient and | Air inlet | chamber | Outlet |
| Sample | material | Amount (g) | CI | amount (g) | H₂O (g) | amount (g) | (° C.) | (° C.) | (° C.) |
| P11 | Malto- | 15.75 | 3747 | 70 | 89.25 | | 170 | 67.9 | 62.3 |
| | dextrin | | | | | | | | |
| P12 | Gelatin | 24 | 3747 | 134 | 215 | | 60 | 26.5 | 32.2 |
| P13 | Mannitol | 14 | 3747 | 60 | 126 | | 160 | 70 | 63 |
| P14 | Methyl | 3.5 | 3747 | 60 | 136.5 | | 160 | 69.6 | 63.7 |
| | cellulose | | | | | | | | |
| P23 | Gelatin | 12 | 3747 | 134 | 215 | Sodium | 160 | 62.2 | 62 |
| | | | | | | sulfate | | | |
| P22 | Methyl | 8.5 | EC1625A | 60 | 331.5 | | 160 | 50.7 | 53.2 |
| | cellulose | | | | | | | | |
| P25 | Malto- | 15.75 | EC1625A | 70 | 89.25 | | 170 | 40.4 | 36.6 |
| | dextrin | | | | | | | | |
| P27 | Malto- | 18 | EC1625A | 40 | 96 | | 170 | 38.2 | 41.9 |
| | dextrin | | | | | | | | |
| P28 | Malto- | 17 | EC1625A | 20 | 80 | | 170 | 43.4 | 40.5 |
| | dextrin | | | | | | | | |
| P31 | Malto- | 12 | EC1625A | 8 | 100 | | 170 | 50.5 | 40.4 |
| | dextrin | | | | | | | | |
| P32 | Gelatin | 12 | EC1625A | 8 | 280 | | 170 | 57.9 | 46.7 |
| | (Pork) | | | | | | | | |
| P33 | Poly- | 12 | EC1625A | 8 | 200 | | 170 | 57.8 | 45.5 |
| | phosphate | | | | | | | | |
| P34 | Gum | 12 | EC1625A | 8 | 200 | | 170 | 58.7 | 40.7 |
| | Acacia | | | | | | | | |
| P35 | Fish | 12 | EC1625A | 8 | 188 | | 160 | 47.7 | 39 |
| | Gelatin | | | | | | | | |
| P36 | ZeMac ™ | 12 | EC1625A | 8 | 100 | | 80 | 34.2 | 29.2 |
| P37 | Gelatin | 3.75 | EC1625A | 8.75 | 48.75 | | 150 | 52 | 45.2 |
| | (porcine) | | | | | | | | |
| P39 | Sodium | 1 | EC1625A | 5 | 69 | Starch | 120 | 35 | 32 |
| | alginate | | | | | | | | |
| P40 | Poly(vinyl | 15 | EC1625A | 15 | 135 | | 120 | 36.2 | 32.4 |
| | alcohol) | | | | | | | | |

CI refers to corrosion inhibitor Corrtreat 3747 or EC1625A

In Table 2A, it is noted that the corrosion inhibitor amount and the matrix material amount can be used to determine an initial weight percent of corrosion inhibitor relative to the combined amount of corrosion inhibitor and matrix material in the feed used for spray drying to form the encapsulated particles. Based on the values in Table 2A, samples P11-P25 and sample P39 contained 80 wt % or more of the corrosion inhibitor (relative to combined weight of corrosion inhibitor and matrix) prior to spray drying. Samples P31-P36 included roughly 40 wt % of corrosion inhibitor (relative to combined weight of corrosion inhibitor and matrix). Samples P27, P28, and P37 included 69 wt %, 54 wt %, and 70 wt % respectively of corrosion inhibitor (relative to combined weight of corrosion inhibitor and matrix).

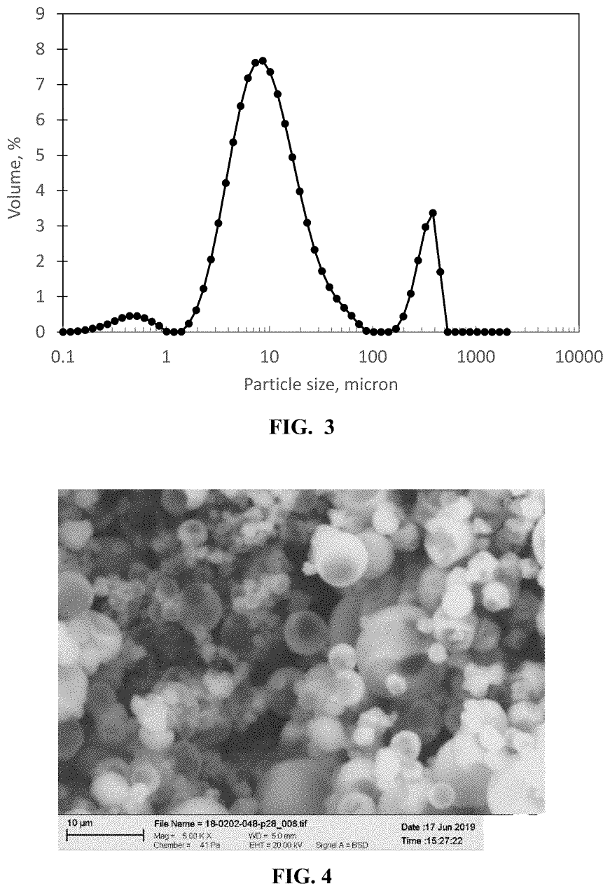

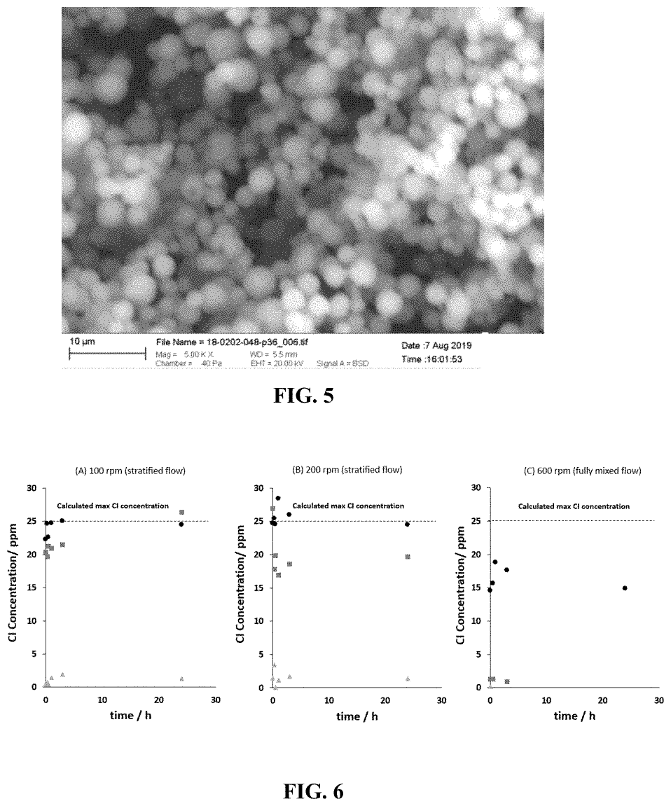

As illustrated in FIGS. 2 and 3, laser diffraction particle size analysis of the dry powder produced by spray drying, respectively, formulations P22 and P28, indicates primary average particle size in the range of 5 to 25 μm. The secondary smaller peak observed over 200 μm was confirmed to be agglomeration of the smaller particles that failed to break apart during the size measurement. FIGS. 4 and 5 are, respectively, electron micrographs of spray dried powders from formulations P28 and P36, confirming the small particle size and spherical morphology.

The particulate compositions in Table 2A correspond to compositions that were made using commercially available corrosion inhibitor formulations. Such commercial corrosion inhibitor formulations typically include 30 wt % or more of solvents, such as methanol, isopropanol, or isobutanol. In Table 2B, additional particulate compositions are shown that were formed using corrosion inhibitor compounds that were substantially free of solvent. In this discussion, “substantially free of solvent” is defined as a particulate composition that includes 5.0 wt % or less of solvent, or preferably 2.0 wt % or less of solvent.

TABLE 2B

| | | Matrix | | | | | | | |
|---|---|---|---|---|---|---|---|---|---|
| | Matrix | material | | CI | | Added | Air inlet | Chamber | Outlet |
| Sample | material | Amount (g) | CI | amount (g) | H₂O (g) | excipient | (° C.) | (° C.) | (° C.) |
| P43 | Gelatin | 10 | Blend A | 10 | 190 | SDS | 140 | 55.8 | 52.8 |
| P44 | Gelatin | 10 | Blend A | 4.29 | 190 | SDS | 140 | 80.4 | 66.5 |
| P51 | Gelatin | 17.5 | Blend B | 17.5 | 300 | SDS | 170 | 75.6 | 68.6 |
| P52 | Gelatin | 17.5 | Blend A | 17.5 | 300 | SDS | 170 | 82.0 | 72.7 |
| P53 | Gelatin | 17.5 | Blend C | 17.5 | 300 | SDS | 180 | 85.8 | 72.9 |

In Table 2B, Blends A, B, and C refer to blends of corrosion inhibitors. All of the corrosion inhibitor blends include two different isomers of benzyldimethyldodecylammonium chloride (available from Sigma Aldrich), which are referred to herein as BC12 and BC16. Blend A included BC12, BC16, and dodecylamine (DDA) in a weight ratio of 4:3:3. Blend B included BC12, BC16, and dodecanethiol (DDT) in a weight ratio of 4:3:3. Blend C included BC12, BC16, and 2-mercaptoethanol in a weight ratio of 4:3:3. In Table 2B, “SDS” is sodium dodecyl sulfate. In P43 and P44, 0.1 g of SDS was added to the formulation. For P51, P52, and P53, 0.18 g of SDS was added to the formulation.

As shown in Table 2B, the weight of corrosion inhibitor relative to the combined weight of corrosion inhibitor plus matrix was 50 wt % for P43, P51, P52, and P53. The weight of corrosion inhibitor relative to the combined weight of corrosion inhibitor plus matrix was lower for P44 at roughly 30 wt %.

### Example 2: Stability of Particulate Compositions Comprising Corrosion Inhibitors

The stability of the matrix materials in oil was tested through solubility studies and the results are shown in Table 3. The stability tests were performed in three types of oil; a light sweet crude oil, a light sour crude oil, and a synthetic polyalphaolefin basestock. For each test, 0.2 g of matrix material was added to 2.5 g of oil. The mixture was stirred with a vortex mixer for 0.5 h and then kept at room temperature for 18 hr. The matrix material was then removed from the liquid with a disposable filter funnel, washed with heptane, and dried under vacuum. The final weight of the matrix material was then measured and the weight loss of the material in oil was calculated. As shown in Table 3, all the selected matrix materials were stable in crude oils, as well as in SpectraSyn™ synthetic polyalphaolefin (PAO4) synthetic base stock, with zero to negligible weight loss.

TABLE 3
Weight loss of various matrix materials in oils (wt. %)

| | Light Sweet | Light Sour | PAO4 synthetic |
|---|---|---|---|
| Matrix material | crude oil | crude oil | basestock |
| Maltodextrin | 0 | 0 | 0.8 |
| Pork gelatin 300 | 0 | 2.0 | 0.5 |
| D-mannitol | 0 | 0 | 0 |
| Methyl cellulose | 0 | 0 | 0 |
| Sodium | 2.0 | 2.2 | 1.7 |
| hexametaphosphate | | | |
| Gum acacia | 0 | 0 | 0.8 |
| Fish gelatin | 0 | 2.8 | 0.7 |
| ZeMac ™ E60 | 0 | 0 | 0 |

The stability of the particulate compositions comprising corrosion inhibitors in oil was tested following the same procedure. As shown in Table 4, the particulate compositions were reasonably stable in oil with less than 10 wt. % weight loss.

TABLE 4
Weight loss of various particulate compositions in oils (wt. %)

| Particulate | Light Sweet | Light Sour | PAO4 synthetic |
|---|---|---|---|
| composition | crude oil | crude oil | basestock |
| P11- Corrtreat 3747 | 8.0 | 0 | 2 |
| Maltodextrin | | | |
| P12 - Corrtreat 3747 | 2.0 | 0 | 0 |
| Gelatin | | | |
| P13 - Corrtreat 3747 | 10.0 | 5.4 | 5.0 |
| D-Mannitol | | | |
| P14 - Corrtreat 3747 | 7.0 | 5.0 | 6.0 |
| Methyl cellulose | | | |
| P28 - EC1625A | 2.0 | 1.0 | 6.0 |
| Maltodextrin | | | |
| P27 - EC1625A | 0 | 3.0 | 3.0 |
| Maltodextrin | | | |
| P25 - EC1625A @ | 11.0 | 5.0 | 4.0 |
| Maltodextrin | | | |
| P22 - EC1625A | 8.0 | 0 | 10.0 |
| methyl cellulose | | | |
| P31 - EC1625A | 0 | 0 | 0 |
| Maltodextrin | | | |
| P32 - EC1625A | 0 | 0 | 2.0 |
| pork gelatin | | | |
| P33 - EC1625A | 0 | 0 | 2.0 |
| sodium | | | |
| hexametaphosphate | | | |
| P34 -EC1625A | 0 | 0 | 5.0 |
| Gum acacia | | | |
| P43 - BC12:BC16:DDA in | — | — | 0 |
| Gelatin (total 50% CI) | | | |
| P44 - BC12:BC16:DDA in | — | — | 0 |
| Gelatin (total 30% CI) | | | |
| P51 - BC12:BC16:DDT in | — | — | 0 |
| Gelatin (total 50% CI) | | | |
| P53 - BC12:BC16:MCE in | — | — | 0 |
| Gelatin (total 50% CI) | | | |

Although the particulate compositions in Table 4 were reasonably stable, the highest weight loss values were observed when exposed to the PAO4 basestock. Additionally, it is noted that P27 and P25 contain the same matrix material (maltodextrin) and corrosion inhibitor package (EC1625A). However, P27 had a lower corrosion inhibitor content in the capsules. As shown in Table 4, P27 also had lower weight loss as compared to P25, which had a higher corrosion inhibitor content. Without being bound by any particular theory, it is believed that the mass loss of encapsulated commercial corrosion inhibitors in oil may be due to two factors. First, higher corrosion inhibitor content can result in additional corrosion inhibitor components being located near the surface of the encapsulated capsule. Such components in the outer layer of capsule can be in direct contact with oil, and may therefore be more likely to be lost. Additionally, it is believed that the substantial solvent content of commercial corrosion inhibitor formulations may play a role. The solvents used in commercial formulations may evaporate during the spray drying process as the air inlet temperature can be higher than the boiling point of the solvents. As the solvents leave a capsule, the porosity of the capsule can be increased, which then facilitates loss of material from deeper within the capsule. Based on these considerations, it is believed that capsules with higher commercial corrosion inhibitor content are prone to have a slightly lower stability in oil due to the microsphere morphology of the capsules.

It is noted that similar weight loss of encapsulated corrosion inhibitors was not observed for the formulations corresponding to P43, P44, P51, and P53. These formulations were tested for weight loss only in the PAO4 basestock environment. No weight loss was observed for any of these formulations. Without being bound by any particular theory, it is believed that the lack of solvent in P43, P44, P51, and P53 resulted in improved stability of the capsules in the PAO4 basestock environment.

The stability of the particulate compositions comprising the corrosion inhibitors in oil under high hydrostatic pressure was also tested. The testing procedure was as follows: 1) add 1.3 g particulate composition in 20 ml PAO4 to a stainless steel pressure reactor, 2) stir the mixture with a vortex mixer for 0.5 hr, 3) keep the solution under high nitrogen gas pressure for defined time period, 4) release the pressure in the pressure reactor and filter of the particulate composition from the mixture with a disposable filter funnel and wash with heptane, 5) dry the particulate composition under vacuum and measure the weight loss. Table 5 lists the high pressure stability test results for formulations P12 and P25 under 800 psi for 48 hr and 2000 psi for 4 hr, respectively. Very low weight loss results suggest that the particulate compositions are relatively stable in oil under high pressure.

TABLE 5

| | Under 800 psi | Under 2000 psi |
|---|---|---|
| Matrix/CI | for 48 hr | for 4 hr |
| P12 - Corrtreat 3747 | 0 | 0 |
| Gelatin | | |
| P25 -EC1625A | — | 3.0 |
| maltodextrin | | |

### Example 3: Partitioning Test Results of Particulate Compositions

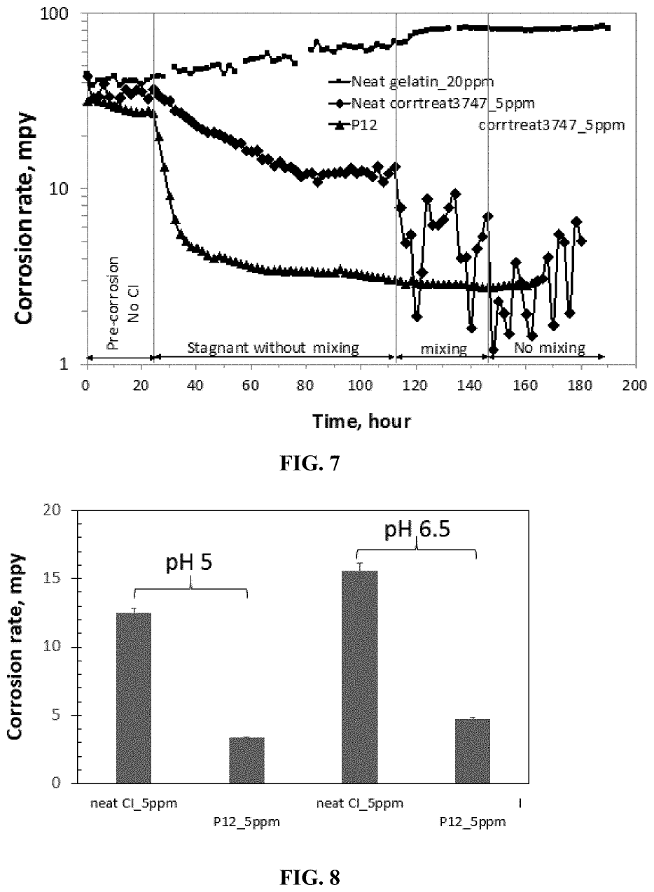

Corrosion inhibitor partitioning tests were conducted on particulate compositions with different matrix materials. For each test, 20 mg of either, a particulate composition according to the present disclosure, 20 mg of liquid neat corrosion inhibitor, or solid matrix material without corrosion inhibitor (blank test) was added to a water oil mixture of 1 L total volume. The mixture contained 80% water/20% oil. The fluid was mixed in a beaker by a stir bar with different rotating speeds (either 100 rpm, 200 rpm, or 600 rpm). While 100 rpm and 200 rpm tests mimic stratified flow condition with a clear oil and water interface, the 600 rpm test mimics more violent flow patterns in which oil and water are fully mixed. Mixing was continued for one hour for each test. After this time, mixing was stopped and the oil and water began to separate. Samples from the water phase were then withdrawn and corrosion inhibitor residuals were measured by methyl orange method (Wang K and Langley D., Ind. Eng. Chem., Prod. Res. Dev., Vol. 14, No. 3, 1975). FIG. 6 shows the partitioning results of neat Corrtreat 3747 (solid squares), particulate composition (P14—Corrtreat 3747 in methyl cellulose; solid circles) and cellulose matrix material alone (solid triangles), in a light sweet crude oil/water mixture at pH 6.5. Based on the 20 mg material added for each test, the maximum water phase corrosion inhibitor residual is calculated to be 25 ppm and which is illustrated by the horizontal dotted line in each of the graphs in FIG. 6. It can be seen that, as expected, no corrosion inhibitor was detected in the water phase when a cellulose matrix material (no corrosion inhibitor included) was added to the system at all flow conditions (all solid triangle data points are close to zero concentration). For neat corrosion inhibitor Corrtreat 3747, under stratified flow conditions (100 rpm and 200 rpm), significant amount of corrosion inhibitor was detected in the water phase (˜20 ppm; solid square data points). However, almost 0 ppm of corrosion inhibitor was detected if neat corrosion inhibitor was added under fully mixed flow condition. This implies that a large amount of corrosion inhibitor is partitioned into the oil phase under fully mixed flow conditions. In contrast, particulate composition (P14—Corrtreat 3747/Methyl cellulose) showed unexpectedly higher partitioning in the water phase (solid sphere data points), as compared to neat corrosion inhibitor. Under stratified conditions, the particulate composition almost reached calculated maximum corrosion inhibitor residual in the water phase. Under fully mixed flow, the particulate composition had an unexpectedly significant amount of corrosion inhibitor residual in the water phase, in contrast to the result of having substantially no corrosion inhibitor residual in the water phase when a neat corrosion inhibitor was added under mixed flow conditions. The results demonstrate that the particulate compositions of the present disclosure can deliver corrosion inhibitor components to a water phase more effectively under either stratified or fully mixed oil-water two phase flow conditions.

### Example 4: Inhibition Performance Results of Particulate Compositions

The inhibition performance of particulate compositions according to the present disclosure as compared to the directly injected corrosion inhibitor solution in an oil and water system was tested. Corrosion tests were conducted in corrosion kettles filled with 80 vol. % 1 wt. % NaCl solution and 20 vol. % of the light sweet crude oil at room temperature. The kettles were continuously purged with 1 bar CO₂ and the pH of the brine phase was adjusted to targeted pH using sodium bicarbonate. Electrochemical corrosion tests were undertaken using a standard three electrode arrangement, suing a platinum wire as counter electrode, a saturated calomel electrode as the reference electrode, and a cylindrical working electrode made from X60 carbon steel.

Before each test, the working electrode was prepared by wet grinding to a 600-grit sand paper finish, rinsed with deionised water, methanol and acetone, and blown dry with nitrogen gas. The dimensions of the electrode were then measured to accurately calculate the current density. A Gamry Reference 600 potentiostat was used to conduct polarization resistance measurements at 1 or 2 hour time intervals where the potential of the working electrode was varied from −10 mV to 10 mV of the corrosion potential (E_{corr}) with a scan rate of 0.2 mV/s. Linear polarization resistance (LPR) (Rₚ, the slope of voltage/current close to E_{corr}) was measured by Gamry Echem Analyst software at +/−5 mV with respect to E_{corr}, and used to calculate the corrosion current I_{corr} using equation (1), with an estimated B value of 0.026 V for CO₂ corrosion:

I_{corr}=B/Rₚ (1)

The resulting I_{corr} in μA·cm⁻² yields the corrosion rate using equation (2)

$$corrosion rate ( mpy ) = \frac{{K}_{p} \times {I}_{corr} \times EW}{ρ} \qquad ( 2 )$$

where Kₚ is a proportionality constant (0.1288 for mpy (mil per year)), and EW is the equivalent weight in gram, ρ is the density of the carbon steel in g/cm³ (7.85 g/cm³).

To demonstrate the change of corrosion rate after the addition of corrosion inhibitors, a 24 hr pre-corrosion of the working electrode in the corrosion kettle was applied for each test before corrosion inhibitor was added to the top of the oil phase in the kettle. The fraction of the active corrosion inhibitor components in the particulate compositions was measured by solubility studies using xylene solvent wash to extract the corrosion inhibitor components into the xylene, thus separating them from the matrix material or by using the methyl orange method. The measured payload, that is, the active corrosion inhibitor concentration in the particulate composition containing Corrtreat 3747 (P12) is ˜30 wt. %, which is similar to the active corrosion inhibitor concentration of neat Corrtreat 3747 solution. The measured payload for the particulate composition containing EC1625A (P25) is ˜60 wt. %, which is about twice the active corrosion inhibitor concentration of neat EC1625A solution.

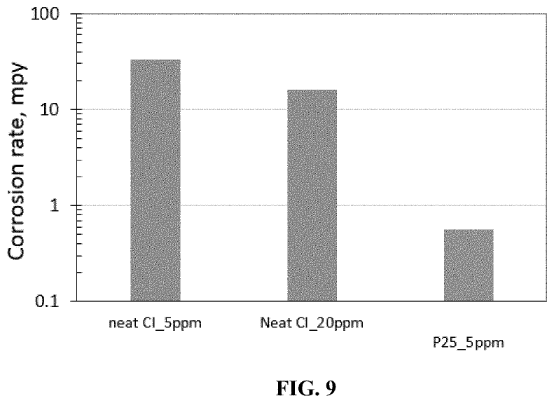

FIG. 7 illustrates the inhibition performance of the particulate composition containing Corrtreat 3747 (P12) as a function of time, compared to directly injected neat Corrtreat 3747 and compared to neat gelatin matrix material, in an oil and water system with pH 5, and 1 wt. % brine at room temperature. It was expected that neat gelatin would not provide any corrosion inhibition and this was indeed the case as demonstrated by the high corrosion rate throughout the duration of the test (solid square data points). The particulate composition containing Corrtreat 3747 (P12) provided higher corrosion inhibition (solid triangle data points) as compared to the directly injected neat Corrtreat 3747 with similar active corrosion inhibitor concentration. After the corrosion rate reached steady state (112 hours into the test) the oil and brine in the kettle were mixed with a magnetic stir bar rotating at a speed of 200 rpm for about 35 hr. No change of inhibition performance for P12 was observed with or without oil/water mixing. However, a stable emulsion formed in the kettle with neat Corrtreat 3747 both during and after mixing, thus the electrochemically measured corrosion rate should not be used to accurately represent the inhibition performance of neat Corrtreat 3747 during and after mixing due to the partially oil-wetted working electrode surface.

FIGS. 8 and 9 illustrate the steady state corrosion rate of particulate compositions containing Corrtreat 3747 (P12) and EC1625A (P25) respectively, as compared to that of the directly injected corresponding corrosion inhibitor.

FIG. 8 illustrates that at both pH 5 and 6.5 the corrosion rate for the particulate composition was 25% of that observed for the neat corrosion inhibitor. FIG. 9 illustrates that the corrosion rate for the particulate composition was remarkably 20-30 times less than for the neat corrosion inhibitor, even when four times the concentration of neat corrosion inhibitor was added. This demonstrates the unexpectedly enhanced efficiency of particulate compositions according to the present disclosure in inhibiting corrosion.

### Example 5: Encapsulated Corrosion Inhibitor Payload

The payload of an encapsulated corrosion inhibitor is defined as the amount of active corrosion inhibitor concentration in the capsules that are formed after spray drying, and is a parameter which is directly related to the properties and performance of encapsulated corrosion inhibitors. It is noted that payload (after forming capsules by spray drying) is distinct from the concentration of corrosion inhibitor in the matrix prior to spray drying to form the capsules. Unfortunately, it is challenging to accurately calculate the payload of encapsulated corrosion inhibitor due to the following two reasons. First, the actual active corrosion inhibitor concentration in a commercial package is unknown as it is proprietary information of the chemical vendors. Secondly, solvent from the commercial corrosion inhibitor package, possibly together with some low molecular weight components, is lost during the spray drying process at high temperature. As a result, the payload of encapsulated corrosion inhibitor in a capsule can only be measured after spray drying. However, quantitative composition analysis of the encapsulated corrosion inhibitor using liquid chromatography-mass spectrometry (LCMS) or nuclear magnetic resonance (NMR) techniques is extremely challenging as both the matrix material and commercial corrosion inhibitor package are complex mixtures of hundreds of unknown molecules. Therefore, the only feasible approaches are to estimate payload of encapsulated corrosion inhibitors via residual measurement (e.g., Methyl Orange colorimetric method) or mass loss measurement with solvent wash. In this study, the solvent wash method was used to estimate the payload of encapsulated corrosion inhibitors.

Table 6 shows the mass loss of selected matrix materials after solubility test in different solvents.

TABLE 6
Weight Loss of Matrix Materials in Various Solvents

| Weight loss, wt. % | Toluene | Xylene | Methanol |
|---|---|---|---|
| Maltodextrin | 3.6 | 7 | 13 |
| Gelatin | 0 | 2 | 8 |
| D-Mannitol | 0 | 1 | 10 |
| Methyl cellulose | 0 | — | 13.3 |
| Gum Acacia | 9 | — | 15.6 |
| Fish gelatin | 4.2 | — | 16.3 |

Apparently, the matrix materials shown in Table 6 are partially soluble in methanol. However, most of the matrix materials are insoluble in toluene and xylene, except for Gum Acacia in Toluene and Maltodextrin in xylene. As active corrosion inhibitor components are organic surfactants, such components are also expected to have good solubility in polar solvents like toluene and xylene. Therefore, toluene and xylene were used for solubility testing of encapsulated corrosion inhibitors for payload estimate.

The estimated payload of the encapsulated CIs based on solubility test in toluene and xylene after taking into account the weight loss of neat matrix materials in the corresponding solvent are listed in Table 7. In Table 7, “total xx % CI” or “total CI>xx %” refers to the weight of corrosion inhibitor relative to the combined weight of corrosion inhibitor and matrix in the mixture prior to spray drying to form the capsules. The payload refers to the amount of corrosion inhibitor that was estimated to end up in the capsules after spray drying, based on the results from the toluene or the xylene wash.

TABLE 7
Payload Estimation by Toluene and Xylene Wash

| | Payload estimate | Payload estimate |
|---|---|---|
| | by toluene | by xylene |
| Encapsulated CI | wash, wt. % | wash, wt. % |
| P11- Corrtreat3747 in Maltodextrin | 32.2 | — |
| (total CI > 80%) | | |
| P12 - Corrtreat3747 in Gelatin | 30.6 | 29.7 |
| (total CI > 80%) | | |
| P13 - Corrtreat3747 in D-Mannitol | 62.8 | — |
| (total CI > 80%) | | |
| P14 - Corrtreat3747 in Methyl | 20 | — |
| cellulose (total CI > 80%) | | |
| P28 - EC1625A in Maltodextrin | 17.8 | — |
| (total 54% CI) | | |
| P27 - EC1625A in Maltodextrin | 30.7 | — |
| (total 69% CI) | | |
| P25 - EC1625A in Maltodextrin | 66.7 | 62.7 |
| (total CI > 80%) | | |
| P22 - EC1625A in Methyl | 68 | — |
| cellulose (total CI > 80%) | | |
| P31 - EC1625A in Maltodextrin | 23.0 | |
| (total 40% CI) | | |
| P32 - EC1625A in Gelatin | 20.3 | 8.8 |
| (total 40% CI) | | |
| P34 - EC1625A in Gum Acacia | 16.7 | — |
| (total 40% CI) | | |
| P43 - BC12:BC16:DDA in Gelatin | 1.6 | 6.4 |
| (total 50% CI) | | |
| P44 - BC12:BC16:DDA in Gelatin | 0 | 0.4 |
| (total 30% CI) | | |
| P51 - BC12:BC16:DDT in Gelatin | 9.1 | 11.2 |
| (total 50% CI) | | |
| P53 - BC12:BC16:MCE in Gelatin | 8.0 | 15.5 |
| (total 50% CI) | | |

As shown in Table 7, for encapsulated commercial corrosion inhibitor packages, compared to the starting raw materials fraction [corrosion inhibitor/(corrosion inhibitor+matrix)] before encapsulation, the estimated payload of all the encapsulated commercial corrosion inhibitors were significantly lower. This is especially true for samples P11, P12 and P14 where the estimated payload was more than 50 wt % lower than the initial fraction of corrosion inhibitor in the raw material.

Without being bound by any particular theory, it is noted that commercial corrosion packages usually contain a substantial amount of volatile solvent like methanol, isobutanol, and/or isopropanol. It is believed that when commercially formulated corrosion inhibitors are used, solvent evaporation during spray drying results in substantially lower payloads in the final encapsulated corrosion inhibitors relative to the concentrations in the initial raw materials used for spray drying. It is also believed that solvent evaporation during spray drying can lead to poor compactness and/or density of the capsule, so that polar solvents like toluene and xylene can penetrate into the capsules and extract additional corrosion inhibitor components.

In contrast to the capsules formed form commercial corrosion inhibitor formulations, for the encapsulated custom corrosion inhibitor blends (P43, P44, P51 and P53), unexpectedly low weight loss was measured after toluene or xylene wash, as shown in Table 7. It is noted that gelatin is stable in toluene and xylene, and because the custom corrosion inhibitor blends did not include solvent, there was no solvent evaporation during spray drying of the custom corrosion inhibitor blends. Without being bound by any particular theory, it is believed that gelatin encapsulated custom corrosion inhibitor blends have unexpectedly good compactness or density, so that solvents like toluene and xylene were not able penetrate into the capsules and extract corrosion inhibitor components.

Based on the limited solubility of gelatin in toluene and xylene, methanol was also used to extract corrosion inhibitor components in the encapsulated custom corrosion inhibitor blends to estimate payload. The results from the methanol extraction are shown in Table 8. In Table 8, the “total xx % CI” refers to the weight of corrosion inhibitor relative to the combined weight of corrosion inhibitor and matrix in the mixture prior to spray drying to form the capsules. The payload refers to the amount of corrosion inhibitor in the capsules after spray drying.

TABLE 8
Methanol Extraction of Custom Corrosion Inhibitor Capsules

| | Estimated payload |
|---|---|
| | by methanol |
| Encapsulated CI | wash, wt. % |
| P43 - BC12:BC16:DDA in Gelatin | 47.2 |
| (total 50% CI) | |
| P44 - BC12:BC16:DDA in Gelatin | 28.1 |
| (total 30% CI) | |
| P51 - BC12:BC16:DDT in Gelatin | 41.3 |
| (total 50% CI) | |
| P52 - BC12:BC16:DDA in Gelatin | 42.0 |
| (total 50% CI) | |
| P53 - BC12:BC16:MCE in Gelatin | 51.5 |
| (total 50% CI) | |

As shown in Table 8, the estimated payload of the encapsulated custom corrosion inhibitor blends is fairly close to the weight percentage of corrosion inhibitor present in the starting raw materials before spray drying. As a result, it is believed that a targeted payload of encapsulated corrosion inhibitors can be readily achieved based on the formulation prior to spray drying when little or no volatile solvent is involved in the formulation used for spray drying. It is also evident that use of corrosion inhibitor blends without solvent (in contrast to fully formulated commercial corrosion inhibitor packages) can increase encapsulation efficiency and payload of the encapsulated corrosion inhibitor products. Moreover, encapsulated corrosion inhibitor blends without solvent may increase the density and potency of the microsphere to achieve controlled release properties. In some aspects, the payload after capsule formation can be 60 wt % or more of the original concentration of the corrosion inhibitor in the formulation used to make the encapsulated corrosion inhibitor, or 70 wt % or more, or 80 wt % or more.

### Example 6—Impact of Encapsulated Corrosion Inhibitor on Demulsification

In crude oil production, water is normally present in crude oil reservoirs and/or is injected to stimulate oil production. Water and oil can mix while rising through the well and when passing through valves and pumps to form water-in-oil emulsions, which are usually referred to as oilfield emulsions. These emulsions can have high stability due to asphaltenes, resins and naphthenates naturally found in many crude oils. Unfortunately, stable emulsions in the oil fields are undesirable for several reasons, including corrosion in transportation pipeline and refining equipment, additional energy input for transportation due to increased viscosities, and reduced commercial value of the extracted crude. As a result, it is desirable to break the emulsions before pipeline transport and refining. Methods to separate water from crude oil can be classified in three main categories: mechanical, electrical, and chemical. Chemical demulsification consists of the addition of relatively small amounts of demulsifiers (usually 10-1000 wppm) to enhance phase separation rates, and is a commonly used method of dehydration of crude oils.

It has been unexpectedly discovered that encapsulated corrosion inhibitors can provide a demulsification benefit in addition to providing the desired corrosion inhibition. Neat corrosion inhibitors do not provide a demulsification benefit. However, it has been discovered that when corrosion inhibitors are provided as encapsulated corrosion inhibitors, demulsification can also occur.

To illustrate and quantify the demulsification benefits of encapsulated corrosion inhibitors, a series of bottle tests were performed. In the bottle tests, either 1) encapsulated corrosion inhibitor, 2) a corresponding neat matrix material, or 3) a corresponding neat corrosion inhibitor or corrosion inhibitor package was added to a pH 5, 1 wt. % NaCl solution at a target concentration to form a first mixture. The first mixture then was added into a 100 ml beaker along with crude oil at either a 4:1 or 1:1 water vs. oil volume ratio to form a second mixture. The second mixture was mixed on a magnetic stir plate at 600 rpm for 10 minutes. The second mixture was then poured into a graduated bottle and water separation was observed over a period of time. A blank test without any chemical addition in the brine was also conducted for comparison.

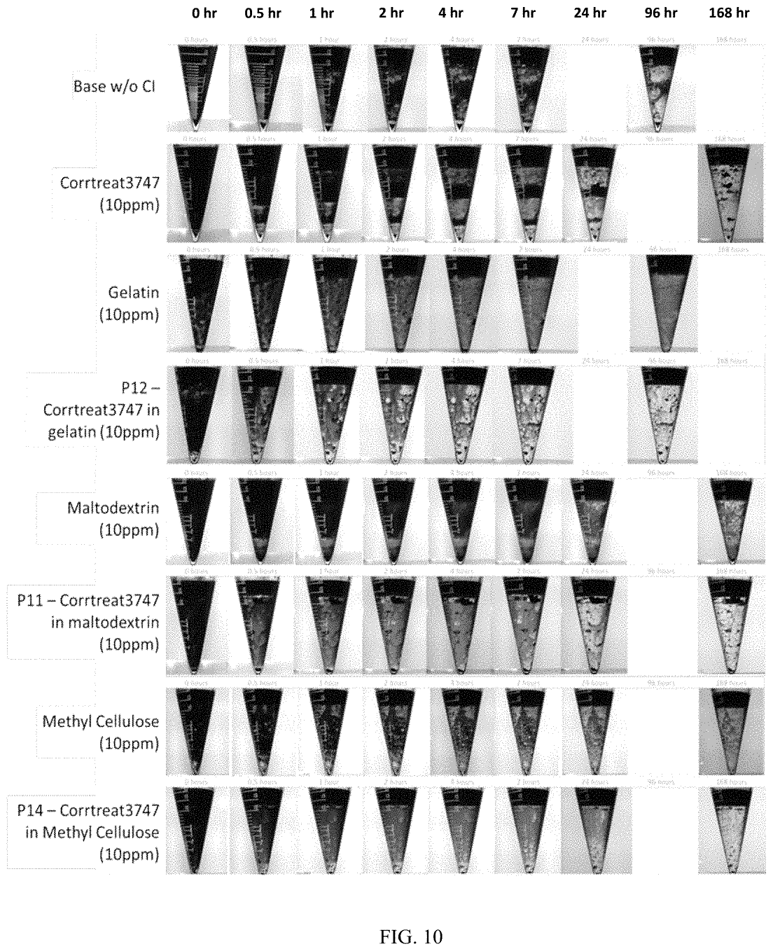

FIG. 10 shows the appearance of the bottles containing various emulsions made from mixing 1) 4 ml of light sweet crude oil, 2) 16 ml brine, and 3) various chemical additions, as a function of time at room temperature. For the baseline without any chemical addition, complete water separation was not observed at the end of 7 day test duration. Instead, large water domains surrounded by oil-continuous films were present. These oil-continuous domains were also observed in the bottle treated with neat corrosion inhibitor package Corrtreat3747. Some turbidity was observed in the water separated from the light sweet crude oil emulsion in bottles treated with neat matrix materials. In contrast, a clean water layer was unexpectedly formed in the bottles when encapsulated corrosion inhibitor was added, demonstrating the benefit of encapsulated Corrtreat3747 in demulsification as compared to neat commercial corrosion inhibitor package Corrtreat3747.

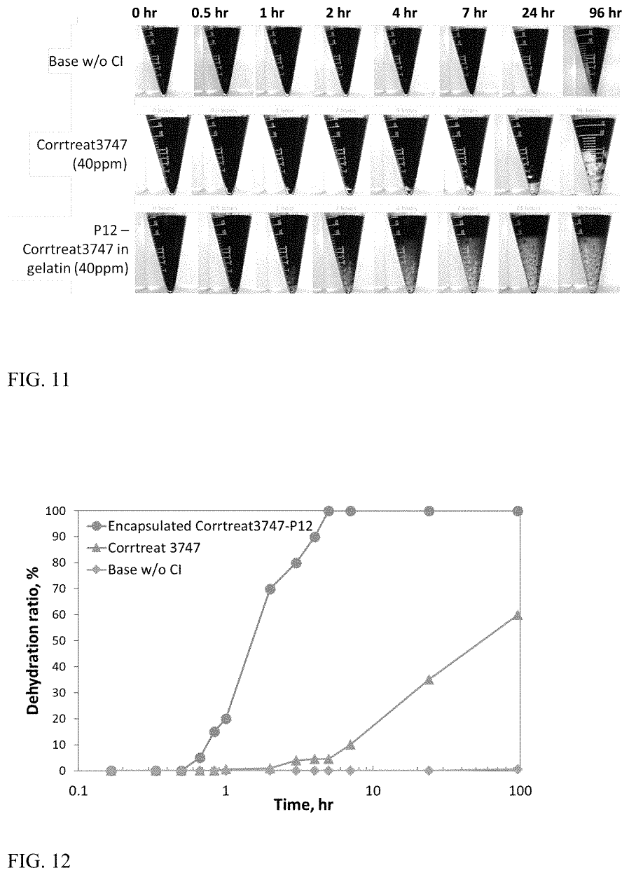

FIG. 11 shows another bottle test results with emulsions made from mixing 1) 10 ml light sour crude oil, 2) 10 ml brine, and 3) 40 ppm neat corrosion inhibitor Corrtreat3747 or 40 ppm encapsulated corrosion inhibitor P12, as a function of time at room temperature.

The measured volume percentage of water separated from the light sour crude oil emulsions as a function of time from the tests shown in FIG. 11 was plotted in FIG. 12. The dehydration ratio in FIG. 12 is calculated by dividing the measured water separated from light sour crude oil emulsions from the bottle test at a given point of time (as shown in FIG. 11) by the volume of water used to make the crude oil emulsion for the bottle tests (which is 10 ml for this test). So FIG. 12 is a plot of volume percentage of water separated from light sour crude oil emulsions as a function of time with or without corrosion inhibitor added into the brine.

For the emulsions shown in FIG. 11, several distinct features could be observed, depending on the brine composition in each cash. No water separation was observed in the blank sample after 96 hr. Oil-continuous domains were present in the bottle with neat corrosion inhibitor Corrtreat3747, while a clear water layer was form in the bottle with encapsulated Corrtreat3747 P12. As shown in FIG. 11 and in the supporting dehydration ratio plot in FIG. 12, the encapsulated corrosion inhibitor provided an unexpectedly faster demulsification speed and improved dehydration ratio, as compared to the neat corrosion inhibitor. Even though neither neat matrix materials nor commercial corrosion inhibitors are currently used as chemical demulsifiers, it is believed that the combination of matrix materials and corrosion inhibitors in an encapsulated corrosion inhibitor provides a synergistic effect, allowing the corrosion inhibitors to unexpectedly also provide demulsification properties.

### Certain Embodiments

Certain embodiments of compositions and methods according to the present disclosure are presented in the following paragraphs.

Embodiment 1 provides a particulate composition comprising a plurality of particles, said particles comprising a water soluble, water swellable, or water degradable matrix material and one or more oil field chemicals, said particles having a morphology selected from;

i) matrix encapsulated; and

ii) core-shell encapsulated.

Embodiment 2 provides a particulate composition according to embodiment 1, wherein the matrix encapsulated morphology is selected from the group consisting of particles comprising, a) matrix material comprising encapsulated oil field chemicals, said oil field chemicals being dispersed throughout the matrix material, b) matrix material comprising encapsulated oil field chemicals, said oil field chemicals being dispersed throughout the matrix material, said matrix material being surrounded by a further layer of matrix material substantially absent oil field chemicals, c) multiple cores comprising oil field chemicals, said cores being encapsulated by matrix material, said matrix material being surrounded by a further layer of matrix material substantially absent oil field chemicals, d) multiple cores comprising oil field chemicals, said cores being encapsulated by matrix material, and combinations thereof.

Embodiment 3 provides a particulate composition according to embodiment 2, wherein variants a) or b) comprise the encapsulated oil or gas field chemicals substantially homogeneously dispersed throughout the matrix material.

Embodiment 4 provides a particulate composition according to any one of embodiments 1 to 3, wherein the matrix material is substantially insoluble in oil.

Embodiment 5 provides a particulate composition according to any one of embodiments 1 to 3, wherein less than 10% by weight of the matrix material dissolves in oil when the particles are exposed to oil.

Embodiment 6 provides a particulate composition according to any one of embodiments 1 to 3, wherein the matrix material is insoluble in oil.

Embodiment 7 provides a particulate composition according to any one of embodiments 1 to 6, wherein the particles are substantially free of water.

Embodiment 8 provides a particulate composition according to any one of embodiments 1 to 6, wherein the particles comprise less than 1% by weight water or are free of water.

Embodiment 9 provides a particulate composition according to any one of embodiments 1 to 8, wherein the particles are substantially free of solvent.

Embodiment 10 provides a particulate composition according to any one of embodiments 1 to 9, wherein the matrix material degrades, swells or dissolves in aqueous acid, brine or acidic brine.

Embodiment 11 provides a particulate composition according to any one of embodiments 1 to 10, wherein the amount of oil field chemicals in the particulate composition is from about 5% by weight to about 95% by weight based on the total weight of oil field chemicals and matrix material.

Embodiment 12 provides a particulate composition according to any one of embodiments 1 to 11, wherein the amount of oil field chemicals in the particulate composition is from about 10% by weight to about 80% by weight, or from about 20% by weight to about 70% by weight, based on the total weight of oil field chemicals and matrix material.

Embodiment 13 provides a particulate composition according to any one of embodiments 1 to 12, wherein the oil field chemicals are selected from the group consisting of corrosion inhibitors, biocides, scale inhibitors, gas hydrate inhibitors, demulsifiers, drag reducing agents and mixtures thereof.

Embodiment 14 provides a particulate composition according to any one of embodiments 1 to 13, wherein the oil field chemicals comprise a liquid, a solid, a dispersion, or mixtures thereof.

Embodiment 15 provides a particulate composition according to any one of embodiments 1 to 14, wherein the oil field chemicals are substantially soluble in water, sparingly soluble in water, or insoluble in water.

Embodiment 16 provides a particulate composition according to embodiment 13, wherein the corrosion inhibitor comprises one or more surfactants selected from a non-ionic surfactant, an ionic surfactant, an amphoteric surfactant, and mixtures thereof.

Embodiment 17 provides a particulate composition according to embodiment 13, wherein the biocide is selected from one or more biocides used to protect and/or control abiotic corrosion and microbially induced corrosion in oil and/or gas transport and/or storage.

Embodiment 18 provides a particulate composition according to any one of embodiments 1 to 17, wherein the matrix material is selected from the group consisting of dextran, maltodextrin, gelatin, sugar alcohols such as mannitol, cellulose, methyl cellulose, cellulose ethers, hydroxypropylmethyl cellulose, hydroxypropyl cellulose, hydroxyethyl cellulose, sodium carboxy methyl cellulose, hyaluronic acid, albumin, starch, derivatized starch, chitin, chitosan, polypeptide, protein, carbohydrate, polysaccharide, metaphosphate such as sodium hexametaphosphate, starch, gum acacia, xanthan gum, pectins, carrageenan, guan gum, polyester, poly(ethylene glycol), poly(lactide), poly(glycolide), poly(ε-caprolactone), poly(hydroxy butyrate), polyacrylic acid, polyacrylamide, N-(2-hydroxypropyl)methacrylamide, poly(anhydride), aliphatic poly(carbonate), poly(orthoester), poly(amino acid), poly(ethylene oxide), poly(phosphazene), polyoxazoline, polyphosphate, poly(vinyl alcohol), polyvinyl pyrrolidone, ethylene maleic anhydride copolymer, divinyl ether maleic anhydride copolymer, polyurethanes or polyureas comprising ester linkages, salts, either organic or inorganic, such as, for example, sodium sulphate, calcium carbonate, magnesium sulphate, citrate salts and combinations thereof.

Embodiment 19 provides a particulate composition according to any one of embodiments 1 to 18, wherein the density of at least some of the particles is greater that the density of water or greater than the density of brine.

Embodiment 20 provides a particulate composition according to any one of embodiments 1 to 19, wherein the density of the particles is greater than 1.00 g/cm3, or greater than 1.05 g/cm3, or greater than 1.10 g/cm3, or greater than 1.15 g/cm3, or greater than 1.20 g/cm3.

Embodiment 21 provides a particulate composition according to any one of embodiments 1 to 19, wherein the density of the particles is between about 1.00 g/cm3 and about 3.00 g/cm3 or between about 1.05 g/cm3 and about 2.00 g/cm3, or between about 1.15 g/cm3 and about 2.00 g/cm3.

Embodiment 22 provides a particulate composition according to any one of embodiments 1 to 21, wherein the particles comprise one or more further solid or liquid components.

Embodiment 23 provides a particulate composition according to any one of embodiments 1 to 21, wherein the particles comprise one or more further solid or liquid components which have a higher density than water or brine.

Embodiment 24 provides a particulate composition according to any one of embodiments 1 to 23, wherein the density of the one or more solid or liquid components is greater than 1.00 g/cm3, or greater than 1.05 g/cm3, or greater than 1.10 g/cm3, or greater than 1.15 g/cm3, or greater than 1.20 g/cm3.

Embodiment 25 provides a particulate composition according to any one of embodiments 1 to 24, wherein the particles comprise a further solid or liquid component which is miscible with water.

Embodiment 26 provides a particulate composition according to embodiment 25, wherein the solid component of selected from the group consisting of alkali metal salts, alkaline earth salts and ammonium salts.

Embodiment 27 provides a particulate composition according to any one of embodiments 1 to 26, wherein the particles are about 10 nm to about 1 mm in size, or about 100 nm to about 500 micron, or about 1 micron to about 250 micron, or about 1 micron to about 100 micron.

Embodiment 28 provides a particulate composition according to any one of embodiments 1 to 27, wherein a first fraction of particles comprise a first set of one or more oil field chemicals encapsulated therein and a second set of particles comprise a second set of one or more oil field chemicals encapsulated therein.

Embodiment 29 provides a method of delivering oil field chemicals to an oil or gas facility comprising the step of:

introducing one or more particulate compositions according to any one of embodiments 1 to 28 to the facility; and

allowing the oil field chemicals to be released from the particles.

Embodiment 30 provides a method according to embodiment 29, wherein the oil or gas facility comprises a multiphase environment.

Embodiment 31 provides a method according to embodiment 30, wherein the multiphase environment comprises an oil/water or gas/water environment.

Embodiment 32 provides a method of delivering oil field chemicals to a water phase of a multiphase environment comprising the steps of:

introducing one or more particulate compositions according to any one of embodiments 1 to 28 to a multiphase environment;

allowing the particles to migrate to the water phase; and

allowing the oil field chemicals to be released from the particles into the water phase.

Embodiment 33, provides a method of delivering oil field chemicals to a water/vessel wall interface of a multiphase environment comprising the steps of:

introducing one or more particulate compositions according to any one of embodiments 1 to 28 to a multiphase environment;

allowing the particles to migrate to the water/vessel wall interface; and

allowing the oil field chemicals to be released from the particles into the water phase.

Embodiment 34 provides a method according to embodiment 32 or embodiment 33, wherein the multiphase environment is an oil/water or gas/water environment.

Embodiment 35 provides a method according to embodiment 34, wherein the water is production water from an oil well.

Embodiment 36 provides a method according to embodiment 34, wherein the oil is crude oil from an oil well.

Embodiment 37 provides a method according to any one of embodiments 31 to 36, wherein the water has a pH less than 7.0, or less than 6.0, or less than 5.0, or less than 4.0.

Embodiment 38 provides a method according to any one of embodiments 29 to 37, wherein, on introduction of the particulate composition, the matrix material degrades, swells, or dissolves so as to release at least some of the oil field chemicals within 24 hours or less, or within 5 hours or less, or within 30 minutes or less, or within 20 minutes or less, or within 10 minutes or less, or within 5 minutes or less.

Embodiment 39 provides a method according to any one of embodiments 29 to 38, wherein at least a portion of the matrix material degrades, dissolves, or swells and continues releasing oil field chemicals for at least 0.1 hours, or at least 1 hour, or at least 10 hours or at least 100 hours after introduction of the particulate composition.

Embodiment 40 provides a method according to any one of embodiments 29 to 39, to wherein least 10% by weight of oil field chemicals contained in the particles (either core shell or matrix morphologies) are released after 0.1 hours from introduction of the particulate composition, or after 1 hour, or after 10 hours or after 100 hours from introduction.

Embodiment 41 provides a method according to any one of embodiments 29 to 40, wherein at least 10%, or at least 1%, or at least 0.1%, or at least 0.01% by weight of the oil field chemicals introduced arrive at the end of the facility or multiphase environment or to a point where another application of the particulate composition is made.

Embodiment 42 provides a method according to any one of embodiments 29 to 41, wherein the particulate composition is introduced as a mixture with crude oil or hydrophobic carrier.

Embodiment 43 provides a method of preparing a particulate composition according to any one of embodiments 1 to 28, the method comprising a step of at least one of atomizing, spray drying, coextruding (including stationary, vibrating nozzle, centrifugal, electrohydrodynamic, nanoencapsulation), coating (including fluid bed and pan), polymerizing (including in-situ and interfacial), solvent evaporation, phase separation, coacervation, sol-gel formation, liposome formation and polymer membrane formation.

Embodiment 44 provides a method according to embodiment 43, the method comprising the step of spray drying a mixture of one or matrix materials and one or more oil field chemicals.

Embodiment 45 provides a method according to embodiment 43, the method comprising the step of atomizing a mixture of one or matrix materials and one or more oil field chemicals.

Embodiment 46 provides a method according to embodiment 43, the method comprising the step of spray chilling a mixture of one or matrix materials and one or more oil field chemicals.

Embodiment 47 provides a method according to embodiment 43, the method comprising the step of coacervating a mixture of one or matrix materials and one or more oil field chemicals.

Embodiment 48 provides a method according to embodiment 43, the method comprising the step of co-extruding a mixture of one or matrix materials and one or more oil field chemicals.

All patents, patent applications and other documents cited herein are fully incorporated by reference to the extent such disclosure is not inconsistent with this disclosure and for all to jurisdictions in which such incorporation is permitted.

Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

The invention claimed is:

1. A particulate composition comprising a plurality of particles, said particles comprising a water soluble, water swellable, or water degradable matrix material and one or more oil field chemicals, said particles having a morphology selected from
i) matrix encapsulated, and
ii) core-shell encapsulated.

2. A particulate composition according to claim 1, wherein the matrix encapsulated morphology is selected from the group consisting of particles comprising, a) matrix material comprising encapsulated oil field chemicals, said oil field chemicals being dispersed throughout the matrix material, b) matrix material comprising encapsulated oil field chemicals, said oil field chemicals being dispersed throughout the matrix material, said matrix material being surrounded by a further layer of matrix material substantially absent oil field chemicals, c) multiple cores comprising oil field chemicals, said cores being encapsulated by matrix material, said matrix material being surrounded by a further layer of matrix material substantially absent oil field chemicals, d) multiple cores comprising oil field chemicals, said cores being encapsulated by matrix material, and combinations thereof.

3. A particulate composition according to claim 2, wherein variants a) or b) comprise the encapsulated oil or gas field chemicals substantially homogeneously dispersed throughout the matrix material.

4. A particulate composition according to claim 1, wherein the particles are substantially free of solvent.

5. A particulate composition according to claim 1, wherein the matrix material is substantially insoluble in oil, or wherein less than 10% by weight of the matrix material dissolves in oil when the particles are exposed to oil, or wherein the matrix material is insoluble in oil.

6. A particulate composition according to claim 1, wherein the particles are substantially free of water, or wherein the particles comprise less than 1% by weight water or are free of water.

7. A particulate composition according to claim 1, wherein the matrix material degrades, swells, dissolves, or a combination thereof in aqueous acid, brine or acidic brine.

8. A particulate composition according to claim 1, wherein the amount of oil field chemicals in the particulate composition is from about 5% by weight to about 95% by weight based on the total weight of oil field chemicals and matrix material.

9. A particulate composition according to claim 1, wherein the oil field chemicals are selected from the group consisting of corrosion inhibitors, biocides, scale inhibitors, gas hydrate inhibitors, demulsifiers, drag reducing agents and mixtures thereof.

10. A particulate composition according to claim 9, wherein the corrosion inhibitor comprises one or more surfactants selected from a non-ionic surfactant, an ionic surfactant, an amphoteric surfactant, and mixtures thereof; or wherein the biocide is selected from one or more biocides used to protect and/or control abiotic corrosion and microbially induced corrosion in oil and/or gas transport and/or storage; or a combination thereof.

11. A particulate composition according to claim 1, wherein the matrix material is selected from the group consisting of dextran, maltodextrin, gelatin, sugar alcohols such as mannitol, cellulose, methyl cellulose, cellulose ethers, hydroxypropylmethyl cellulose, hydroxypropyl cellulose, hydroxyethyl cellulose, sodium carboxy methyl cellulose, hyaluronic acid, albumin, starch, derivatized starch, chitin, chitosan, polypeptide, protein, carbohydrate, polysaccharide, metaphosphate such as sodium hexametaphosphate, starch, gum acacia, xanthan gum, pectins, carrageenan, guan gum, polyester, poly(ethylene glycol), poly(lactide), poly(glycolide), poly(ε-caprolactone), poly(hydroxy butyrate), polyacrylic acid, polyacrylamide, N-(2-hydroxypropyl)methacrylamide, poly(anhydride), aliphatic poly(carbonate), poly(orthoester), poly(amino acid), poly(ethylene oxide), poly(phosphazene), polyoxazoline, polyphosphate, poly(vinyl alcohol), polyvinyl pyrrolidone, ethylene maleic anhydride copolymer, divinyl ether maleic anhydride copolymer, polyurethanes or polyureas comprising ester linkages, salts, either organic or inorganic, such as, for example, sodium sulphate, calcium carbonate, magnesium sulphate, citrate salts and combinations thereof.

12. A particulate composition according to claim 1, wherein the density of the particles is greater than 1.00 g/cm³, or wherein the density of the particles is between about 1.00 g/cm³ and about 3.00 g/cm³.

13. A particulate composition according to claim 1, wherein the particles comprise one or more further solid or liquid components which have a higher density than water or brine, or wherein the density of the one or more solid or liquid components is greater than 1.00 g/cm³.

14. A particulate composition according to claim 13, wherein a further solid component is selected from the group consisting of alkali metal salts, alkaline earth salts and ammonium salts.

15. A particulate composition according to claim 1, wherein a first fraction of particles comprise a first set of one or more oil field chemicals encapsulated therein and a second fraction of particles comprise a second set of one or more oil field chemicals encapsulated therein.

16. A method of delivering oil field chemicals to a water phase of a multiphase environment comprising:
introducing one or more particulate compositions to a multiphase environment, the one or more particulate compositions comprising a plurality of particles, said particles comprising a water soluble, water swellable, or water degradable matrix material and one or more oil field chemicals, said particles having a morphology selected from i) matrix encapsulated, and ii) core-shell encapsulated;
migrating at least a portion of the one or more particulate compositions to the water phase; and
releasing the oil field chemicals from the one or more particulate compositions into the water phase.

17. A method according to claim 16, wherein the multiphase environment is an oil/water or gas/water environment.

18. A method according to claim 16, wherein, on introduction of the one or more particulate compositions, the matrix material degrades, swells, or dissolves so as to release at least some of the oil field chemicals within 30 minutes or less; or wherein at least a portion of the matrix material degrades, dissolves, or swells and continues releasing oil field chemicals for at least 1 hour after introduction of the one or more particulate compositions; or a combination thereof.

19. A method according to claim 16, wherein at least 10% by weight of oil field chemicals contained in the particles (either core shell or matrix morphologies) are released after 0.1 hours from introduction of the one or more particulate compositions; or wherein at least 1% by weight of the oil field chemicals introduced arrive at the end of the multiphase environment or to a point where another application of the one or more particulate compositions is made; or a combination thereof.

20. A method according to claim 16, wherein the one or more particulate compositions are introduced as a mixture with crude oil or hydrophobic carrier.

21. A method according to claim 16, wherein the multiphase environment comprises a multiphase environment in an oil or gas facility, or wherein the oil field chemicals are delivered to a water/vessel wall interface, or a combination thereof.

22. A method according to claim 16, wherein the one or more particulate compositions are substantially free of solvent.

23. A method according to claim 16, wherein the multiphase environment comprises an emulsion of oil and water, and wherein introducing the one or more particulate compositions to the multiphase environment comprises separating at least a portion of the emulsion into separate water and oil phases.

24. A method of preparing a particulate composition according to claim 1, the method comprising at least one of atomizing, spray drying, coextruding (including stationary, vibrating nozzle, centrifugal, electrohydrodynamic, nanoencapsulation), coating (including fluid bed and pan), polymerizing (including in-situ and interfacial), solvent evaporation, phase separation, coacervation, sol-gel formation, liposome formation and polymer membrane formation.
